(19) United States
(12) Patent Application Publication
(10) Pub. No.: US 2026/0100918 A1
(43) Pub. Date: Apr. 9, 2026

(54) CONFIGURABLE PACKET SWITCH FOR HANDLING DATA PACKET TRAFFIC

(71) Applicant: Texas Instruments Incorporated, Dallas, TX (US)

(72) Inventors: Sriramakrishnan Govindarajan, Bangalore (IN); Siddharth Vadapalli, Hyderabad (IN); Pradeep Hn, Kundapura (IN)

(21) Appl. No.: 19/095,874

(22) Filed: Mar. 31, 2025

(30) Foreign Application Priority Data
Oct. 3, 2024 (IN) 202441074784

(51) Int. Cl. H04L 49/111

(52) U.S. Cl. CPC H04L 49/111

(57) ABSTRACT

Various embodiments of the present disclosure relate to handling network traffic in a packet switch having a first, second, and third port, and a switch fabric coupled to the ports. In one example embodiment a technique for routing a data packet destined for at least a recipient coupled to the first port is provided. The technique includes receiving a data packet at the second port and transmitting the data packet to the switch fabric. Next, the technique includes routing the data packet from the switch fabric to the third port. Then, the technique includes transmitting the data packet from the third port back to the switch fabric with an indication to route the data packet to the first port. Finally, the technique includes routing the data packet from the switch fabric directly to the first port and transmitting the data packet from the first port to the recipient.

### CROSS-REFERENCE TO RELATED APPLICATION

This application is related to, and claims the benefit of priority to, India Provisional Patent Application No 202441074784, filed on Oct. 3, 2024, and entitled “FLEXIBLE MULTI-HOST MULTI-PORT TRAFFIC HANDLING”, which is hereby incorporated by reference in its entirety.

### TECHNICAL FIELD

Aspects of the disclosure are related to ethernet switches, and in particular, to handling network traffic within the context of a packet switch.

### BACKGROUND

A packet switch is a network device that enables communication between multiple network endpoints. Typically, a packet switch includes one or more host ports, one or more media access control (MAC) ports, and a switch fabric. A host port is a network port that connects the packet switch to a primary device, while a MAC port is a network port that connects the packet switch to a secondary device. For example, within automotive applications, the host port may connect to the processing cores of a system on a chip (SoC), while the MAC ports connect to various peripherals (e.g., infotainment system, navigation unit, and the telematics control unit). Additionally, the MAC ports may connect the packet switch to other network endpoints within the automobile, such as an additional packet switch. The switch fabric refers to circuitry that determines the appropriate ports for routing a data packet. For example, the switch fabric may include a crossbar switch with control logic. A crossbar switch provides pathways for connecting the ports of the packet switch. The control logic analyzes the contents of a data packet and configures the crossbar switch to transmit the data packet from a source (e.g., via a primary port) to an appropriate recipient (e.g., via a MAC port).

Data packets may be classified as various types of traffic, including unicast, multicast, and broadcast traffic. Unicast traffic is a one-to-one communication where a data packet is sent from a source to a single recipient. Alternatively, multicast and broadcast traffic are one-to-many communication where a data packet is sent from a source to multiple recipients, with broadcast traffic being sent to all possible recipients.

An SOC having multiple processing cores can create challenges when communicating multicast and broadcast traffic within a packet switch. Consider an example where a singular host port is coupled to multiple processing cores of a primary device. In other words, the singular host port is “shared” by the different processing cores of the primary device. However, when a MAC port receives a data packet that is required by multiple applications running on the processing cores, the switch fabric can only route a single copy of the data packet to the host port. This is because the switch fabric is only capable of determining the number of intended recipient ports rather than the number of intended recipients. As a result, the host port cannot simultaneously transmit the data packet to each processing core of the primary device. Thus, packet switches generally have to include one host port for each processing core of the primary device. The increased number of host ports consumes more area and resources of the SoC and increases the cost of the packet switch. Furthermore, once a primary device is given, the number of host ports is fixed, thereby limiting the applications of the packet switch for a primary device having a different number of processing cores.

Thus, it is desirable to have a packet switch with more port flexibility for transmitting multicast and broadcast traffic.

### SUMMARY

Disclosed herein is technology, including systems, methods, and devices for handling network traffic within the context of a configurable packet switch.

In one example embodiment, a packet switch includes a first port, a second port, a third port, and a switch fabric coupled to the first, second, and third ports. In an implementation, the second port is configured to receive a data packet directed to a recipient coupled to the first port and transmit the data packet to the switch fabric. In response, the switch fabric is configured to route the data packet to the third port (not the first port, at first), and the third port is configured to transmit the data packet back to the switch fabric with an indication to further route the data packet to the first port. The switch fabric is then configured to route the data packet to the first port based on the indication from the third port. Once routed, the first port is configured to transmit the data packet to the recipient coupled to the first port.

In a second example embodiment, a system includes a packet switch and multiple recipients coupled to the packet switch, such that the packet switch includes a first port, second port, third port, and a switch fabric coupled to the first, second, and third ports. In an implementation, the second port is configured to receive a data packet directed to a recipient of the multiple recipients and transmit the data packet to the switch fabric. In response, the switch fabric is configured to route the data packet to the third port. The third port is then configured to transmit the data packet back to the switch fabric with an indication to route the data packet to the first port. In response, the switch fabric is configured to route the data packet to the first port based on the indication from the third port. Once routed, the first port is configured to transmit the data packet to the recipient.

In a third example embodiment, a packet switch includes a first port, a second port, and a switch fabric coupled to the first and second ports. In an implementation, the first port is configured to receive, from a source corresponding to the second port, a data packet directed to one or more recipients. Once received, the first port is configured to transmit the data packet to the switch fabric with an indication to route the data packet to one or more other ports associated with the one or more recipients via the second port.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIGS. 2A and 2B illustrate methods in various implementations.

FIG. 3A illustrates a sequence diagram in an implementation.

FIG. 3B illustrates an operational scenario in an implementation.

FIG. 4A illustrates another sequence diagram in an implementation.

FIG. 4B illustrates another operational scenario in an implementation.

FIG. 5 illustrates a switch fabric in an implementation.

FIGS. 6A and 6B illustrate switch fabric processes in various implementations.

FIG. 7 illustrates another system in an implementation.

FIGS. 8A and 8B illustrate processes in various implementations.

FIGS. 9A and 9B illustrate additional processes in various implementations.

FIGS. 10A-10E illustrate additional operational scenarios in various implementations.

### DETAILED DESCRIPTION

Systems, methods, and devices are disclosed herein which provide an improved process for handling network traffic within the context of a packet switch. The disclosed technique(s) may be implemented in the context of hardware, software, firmware, or a combination thereof to provide a configurable packet switch that is capable of transmitting data packets to multiple recipients in tandem.

In one example embodiment, a configurable packet switch including a first port, a second port, a third port, a fourth port, and a switch fabric coupled to the ports is provided. The first, second, third, and fourth ports are network ports that each correspond to a network endpoint. For example, the first port may represent a host port that may connect to multiple processing cores of a system on a chip (SoC). The second port may represent a media access control (MAC) port that may connect to a peripheral, e.g., a camera. The third and fourth ports may represent reflection ports which correspond to the multiple processing cores of the SoC. For example, if the SOC includes three processing cores, the first port may correspond to a first processing core of the SoC, while the third and fourth ports may respectively correspond to a second and third processing core of the SoC.

In an implementation, the second port may be repurposed to operate as a reflection port, while the third and fourth ports may be repurposed to operate as MAC ports. When operating as a reflection port, the port serves as a host port for a corresponding processing core of the SoC. Alternatively, when operating as a MAC port, the port serves as a MAC port for a corresponding peripheral.

Advantageously, the proposed technology provides a packet switch which may adjust its ports based on the intended application. For example, if a packet switch includes an N number of host ports and an M number of MAC ports (e.g., N host ports, M MAC ports), the packet switch may be configured to have from (N+1 host ports, M−1 MAC ports) to (N+M−1 host ports, 1 MAC ports), assuming to retain at least one MAC port for communication with peripheral(s). As a result, the proposed technology provides a configurable packet switch capable of delivering data packets to multiple recipients in tandem.

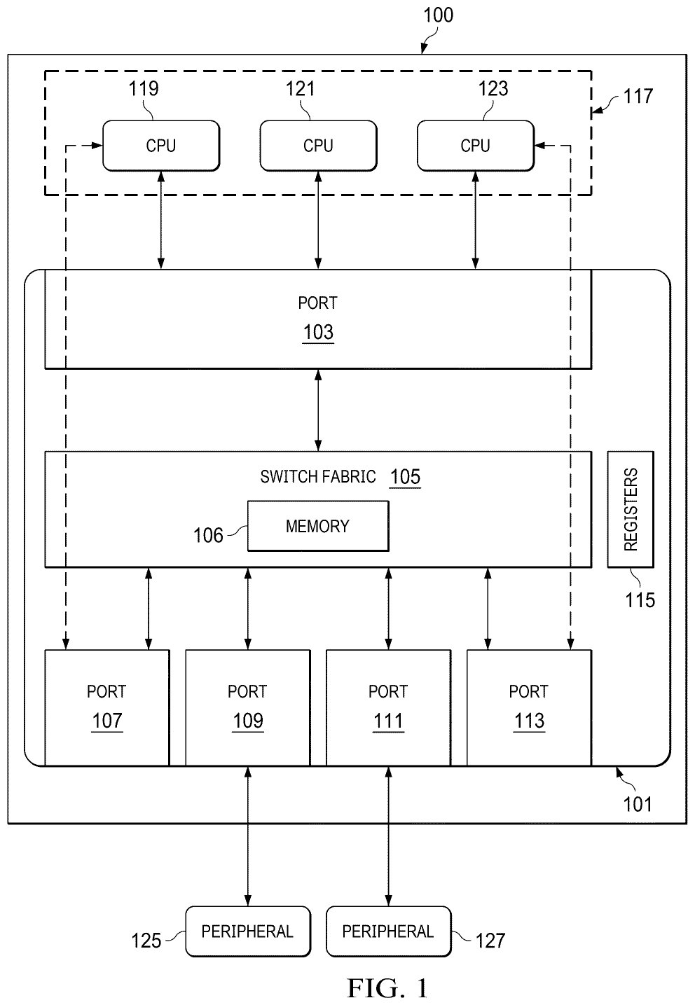

Turning now to the Figures, FIG. 1 illustrates system 100 in an implementation. System 100 is representative of an exemplary system that utilizes a packet switch to enable communication between various network endpoints. For example, system 100 may depict a packet switch within an automotive network, data center, telecommunication network, industrial automation system, or another application of the like. System 100 includes, but is not limited to, packet switch 101 and primary device 117 (e.g., a set of processing cores or CPUs), and is coupled to peripherals 125 and 127. In one embodiment, system 100 may represent an SOC, while peripherals 125 and 127 may represent peripheral devices external to the SOC.

Packet switch 101 represents a networking device that facilitates the communication of system 100. For example, packet switch 101 may include an ethernet switch capable of transmitting data packets between a source and one or more recipients. The source represents the module which generates the data packet, while the one or more recipients represent one or more modules which consume the data packet. Packet switch 101 includes host port 103, switch fabric 105, port 107, port 109, port 111, port 113, memory 106, and one or more registers 115.

Host port 103 is representative of a network port that may be used to connect packet switch 101 to a primary device. For example, host port 103 may connect packet switch 101 to CPUs 119, 121, and 123. In an implementation, host port 103 transmits data packets to, and receives data packets from, CPUs 119, 121, and 123. For example, host port 103 may receive data packets which are destined for CPUs 119, 121, and 123, or data packets which are destined for peripherals 125 and 127.

Any of ports 107, 109, 111, and 113 may be used to connect packet switch 101 to the secondary devices that are coupled to system 100. For example, port 109 may connect packet switch 101 to peripheral 125, while port 111 connects packet switch 101 to peripheral 127. In an implementation, ports 109 and 111 are MAC ports which respectively transmit data packets to, and receive data packets from, peripherals 125 and 127.

Peripherals 125 and 127 represent secondary devices that are coupled to system 100. For example, peripherals 125 and 127 may represent network switches, storage devices, sensors, displays, communication modules, peripheral controllers, and other endpoint devices of the like which interact with system 100. It should be noted that the peripherals coupled to system 100 are not limited to two peripherals 125 and 127, but for the purposes of explanation, peripherals 125 and 127 will be discussed herein. In one embodiment, there may be fewer or more peripherals which communicate with system 100.

In an implementation, to facilitate communication between a single host port 103 and multiple modules (e.g., CPUs 119, 121, and 123, etc.) of primary device 117, any of ports 107, 109, 111, and/or 113 may be configured to become a reflection port so as to reflect communications to and from one of the modules of the primary device, to host port 103. This configuration may preclude the respective one of ports 107, 109, 111, or 113 from being used with a peripheral. In other words, once a port is configured as a reflection port, it may no longer be used for connection with a peripheral. For example, port 107 may be configured as a reflection port for CPU 119, while port 113 may be configured as a reflection port for CPU 123. Thus, in the illustrated embodiment, ports 107 and 113 are configured as reflection ports which serve as host ports for the respective processing core. For example, if CPU 119 transmits a data packet to host port 103, then host port 103 determines that the data packet originated from CPU 119, and in response, transmits the data packet directly to port 107 via switch fabric 105. Similarly, if CPU 123 transmits a data packet to host port 103, then host port 103 determines that the data packet originated from CPU 123, and in response, transmits the data packet directly to port 113 via switch fabric 105. Alternatively, if CPU 121 transmits a data packet to host port 103, then host port 103 determines that the data packet originated from CPU 121, and in response, transmits the data packet to switch fabric 105 to cause switch fabric 105 to determine the intended recipient ports for the data packet.

In an implementation, host port 103 analyzes the data path metadata of a data packet to determine which CPU originated the data packet. The data path metadata may include a parameter which identifies the path that was taken to transmit the data packet from primary device 117. For example, if host port 103 receives a data packet from primary device 117, then host port 103 may analyze the data path metadata of the data packet to determine if the data packet was transmitted across the data path that corresponds to CPU 119, CPU 121, or CPU 123. As a result, host port 103 may determine if the data packet is intended to be transmitted to port 107, port 113, or switch fabric 105. In an implementation, to determine the intended recipient port for the data packet, host port 103 performs a comparison between the data-path metadata and data stored in registers 115. For example, registers 115 may store programmable parameters which link data paths to a specific reflection port, e.g., CPU 119 associated with port 107, CPU 123 associated with port 113, etc. As such, host port 103 may perform a comparison between the data-path metadata and the programmable parameters to determine if the data packet from a CPU is intended to be transmitted to port 107, port 113, or switch fabric 105.

Switch fabric 105 represents circuitry that includes pathways for connecting the ports of packet switch 101. For example, switch fabric 105 may include a crossbar switch that includes pathways for connecting ports 103, 107, 109, 111, and 113 to each other. In an implementation, switch fabric 105 includes logic for determining and selecting the appropriate pathways within the crossbar switch for routing received data packets. For example, switch fabric 105 may include switch routing logic, that when executed, causes switch fabric 105 to classify a data packet as unicast traffic, multicast traffic, or broadcast traffic.

As described above, unicast traffic is a type of network communication where a data packet is sent from a source to a single recipient. For example, if CPU 119 generates a data packet that is exclusively destined for peripheral 125, then switch fabric 105 classifies the data packet as unicast traffic. Multicast traffic is a type of network communication where a data packet is sent from a source to multiple recipients. For example, if CPU 119 generates a data packet that is destined for peripherals 125 and 127, then switch fabric 105 classifies the data packet as multicast traffic. Broadcast traffic is a type of network communication where a data packet is sent from a source to all possible recipients. For example, if peripheral 125 generates a data packet destined for peripheral 127 and CPUs 119, 121, and 123, then switch fabric 105 classifies the data packet as broadcast traffic.

In an implementation, to classify a data packet as unicast, multicast, or broadcast traffic, switch fabric 105 analyzes an identifier of the data packet. The identifier of the data packet may include a unique value, or set of values, which specifies the source and recipient(s) for the data packet. For example, the identifier of a data packet may include the source and recipient MAC addresses, internet protocol (IP) addresses, port numbers, or virtual local area network identifiers (VLAN IDs). In an implementation, switch fabric 105 includes memory 106. Memory 106 is representative of a storage device that stores a look-up table for associating the identifiers of a data packet to specific ports. For example, the look-up table may correlate the MAC address contained in the data packets transmitted from CPU 119 with port 107, the MAC address contained in the data packets transmitted from CPU 121 with host port 103, the MAC address contained in the data packets transmitted from CPU 123 with port 113, the MAC address contained in the data packets transmitted from peripheral 125 with port 109, the MAC address contained in the data packets transmitted from peripheral 127 with port 111, and so on. During operation, switch fabric 105 may reference the look-up table to determine the intended recipient port, or ports, for routing a data packet.

In an implementation, the ports of packet switch 101 are configurable. For example, ports 107, 109, 111, and 113 may either operate in a normal mode or a reflection mode. When operating under the normal mode, the port serves as a regular MAC port that is coupled to a secondary device. Alternatively, when operating under the reflection mode, the port serves as a reflection port that corresponds to a module of the primary device, e.g., one of CPUs 119, 121, 123 of primary device 117. In an implementation, packet switch 101 includes registers 115 for controlling the operative modes of ports 107, 109, 111, and 113. For example, registers 115 may store programmable attributes which enable the corresponding port to either operate under the reflection mode or the normal mode. Thus, registers 115 may be accessed by switch fabric 105 and/or any of ports 107, 109, 111, and 113 to determine the configuration of a respective port and to determine the appropriate actions to take.

The programmable attributes are representative of values which establish the association between a reflection port and a corresponding processing core of the primary device. For example, the programmable attribute corresponding to port 107 may establish the association between port 107 and CPU 119. Similarly, the programmable attribute corresponding to port 113 may establish the association between port 113 and CPU 123. In an implementation, if the programmable attribute is set to a first value (e.g., “enabled”), then the corresponding port operates under the reflection mode. Alternatively, if the programmable attribute is set to a second value (e.g., “disabled”), then the corresponding port operates under the normal mode. For example, if the programmable attribute corresponding to port 107 is enabled, then port 107 operates under the reflection mode. Alternatively, if the programmable attribute corresponding to port 107 is disabled, then port 107 operates under the normal mode.

CPUs 119, 121, and 123 represent the processing cores of the primary device 117. It should be noted that CPUs 119, 121, and 123 are not limited to traditional CPUs, and may instead represent other types of processing units, including digital signal processors (DSPs), graphics processing units (GPUs), field-programmable gate arrays (FPGAs), microcontroller units (MCUs), application-specific integrated circuits (ASICs), or another general purpose processor (GPP) or the like, but for the purposes of explanation, CPUs will be discussed herein. Additionally, it may be appreciated that, although system 100 is illustrated to include primary device 117, primary device 117 may instead function as its own system. For example, packet switch 101 and primary device 117 may represent separate chips, rather than being incorporated within one single chip.

Advantageously, system 100 provides a configurable packet switch which may adjust the numbers of its host and MAC ports based on the intended application. As a result, system 100 provides an environment for operating a packet switch that is better suited for handling multicast and broadcast traffic.

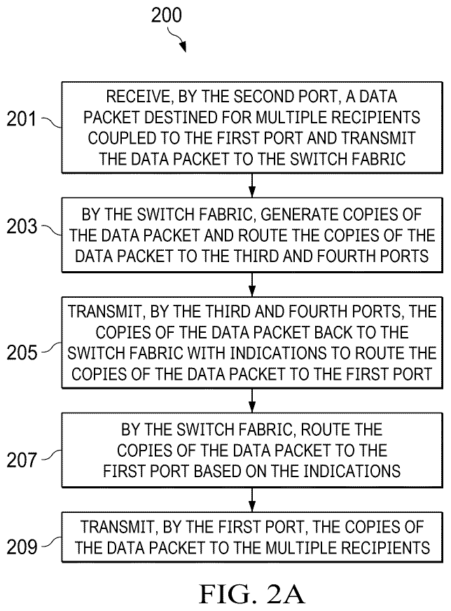

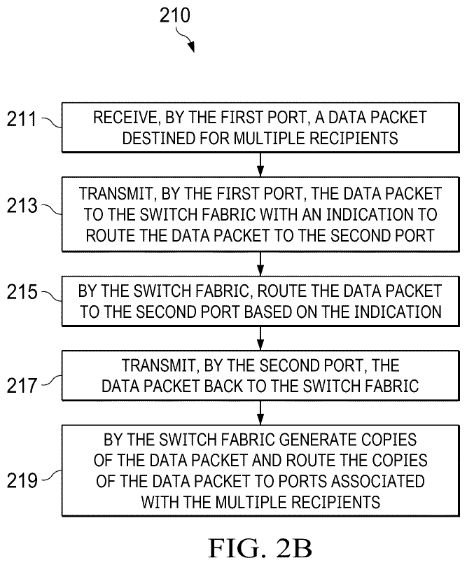

FIGS. 2A and 2B respectively illustrate methods 200 and 210 in an implementation. Methods 200 and 210 are representative of techniques for handling multicast and broadcast traffic within a packet switch. More specifically, method 200 provides a technique for transmitting a data packet from a secondary device to a primary device of the associated system (e.g., from peripheral 125 to CPUs 119 and 123), while method 210 provides a technique for transmitting a data packet in an opposite direction (e.g., from CPU 123 to peripherals 125 and 127). Methods 200 and 210 may be implemented in the context of hardware, firmware, or software to cause a system to operate as follows, referring parenthetically to the steps in FIGS. 2A and 2B. For the purposes of explanation, methods 200 and 210 will be explained with respect to the elements of FIG. 1. This is not meant to limit the applications of methods 200 and 210, but rather to provide an example for purposes of illustration.

To begin method 200, port 109 receives a data packet from peripheral 125 and transmits the data packet to switch fabric 105 (step 201). For example, peripheral 125 may be representative of an image sensor that collects packets of image data for analysis by CPUs 119 and 123. Next, switch fabric 105 analyzes the contents of the data packet via the switch routing logic. The switch routing logic may include software, firmware, hardware, or a combination thereof, that enables switch fabric 105 to identify the intended recipient ports for routing data packets. For example, the switch routing logic may be realized as hardware-based state machine logic. Additionally, the switch routing logic may include firmware that dynamically updates the data paths and/or an address-related look-up table for routing a data packet. In an implementation, the switch routing logic causes switch fabric 105 to utilize the look-up table stored by memory 106 to determine if the data packet is directed to multiple intended recipient ports, such as ports 107 and 113.

Next, switch fabric 105 generates copies of the data packet based on the number of intended recipient ports and routes the copies of the data packet to the respective recipient ports (step 203). For example, if switch fabric 105 determines that the data packet is intended for ports 107 and 113, then, switch fabric 105 classifies the data packet as multicast traffic and generates two copies of the data packet. Once generated, switch fabric 105 routes the first copy of the data packet to port 107 and routes the second copy of the data packet to port 113. In response, ports 107 and 113 respectively transmit the first and second copies of the data packet back to switch fabric 105 with an indication to route the first and second copies of the data packet to host port 103 (step 205). For example, ports 107 and 113 may each assert a reflect-to-host (RTH) signal to the switch fabric with respect to the first and second copies of the data packet. The RTH signals may cause switch fabric 105 to bypass the switch routing logic and route the copies of the data packet directly to host port 103 (step 207). As described below (step 209), by bypassing the switch routing logic, switch fabric 105 may not have to access a look-up table to determine destinations and/or data paths for routing the first and second copies of the data packet.

In an implementation, when routing the first and second copies of the data packet directly to host port 103, switch fabric 105 appends metadata to the first and second copies of the data packet. For example, switch fabric 105 may access registers 115 and append the programmable attribute corresponding to port 107 as metadata to the first copy of the data packet. Similarly, switch fabric 105 may append the programmable attribute corresponding to port 113 as metadata to the second copy of the data packet. In an implementation, the metadata is appended to the copies of the data packet via a sideband signal. For example, when switch fabric 105 is routing the first copy of the data packet directly to host port 103, switch fabric 105 may also route a sideband signal containing the corresponding metadata to host port 103. Similarly, when switch fabric 105 is routing the second copy of the data packet directly to host port 103, switch fabric 105 may also route a sideband signal containing the corresponding metadata to host port 103. In response, host port 103 may determine that the first copy of the data packet is intended for CPU 119 based on the first copy being reflected by port 107 as indicated by the metadata, while the second copy of the data packet is intended for CPU 123 based on the second copy being reflected by port 113 as indicated by the metadata. Host port 103 may then transmit the first copy of the data packet to CPU 119 and transmit the second copy of the data packet to CPU 123 (step 209).

Turning now to FIG. 2B, to begin method 210, host port 103 receives a data packet from CPU 123 (step 211). For example, host port 103 may receive a data packet intended for peripherals 125 and 127. Next, host port 103 analyzes the data path metadata of the data packet to determine the intended recipient ports for the data packet. For example, host port 103 may compare the data path metadata to the programmable parameters stored by registers 115 to determine that the data packet was transmitted across the data path that corresponds to CPU 123, and in response, determine that the data packet is intended for port 113. Once determined, host port 103 transmits the data packet to switch fabric 105 with an indication to route the data packet to port 113 (step 213). For example, the indication may include a switch-routing-bypass (SRB) signal that causes switch fabric 105 to bypass the switch routing logic and route the data packet directly to port 113. In an implementation, the SRB signal is asserted via one or more wires which connects host port 103 to switch fabric 105. For example, host port 103 may cause the wires to form a binary value that corresponds to the index of port 113 and serves as the asserted SRB signal. As a result, switch fabric 105 bypasses the switch routing logic and directly routes the data packet from host port 103 to port 113 (step 215).

Next, port 113 transmits the data packet back to switch fabric 105 (step 217). For example, port 113 may determine that the SRB signal was asserted, and in response, deassert the RTH signal and transmit the data packet to switch fabric 105. Switch fabric 105 may then analyze the identifier of the data packet via the switch routing logic to determine if the data packet includes unicast, multicast, or broadcast traffic. For example, switch fabric 105 may utilize the look-up table stored by memory 106 to determine that the intended recipient ports for routing the data packet include ports 109 and 111. As a result, switch fabric 105 classifies the data packet as multicast traffic and generates two copies of the data packet.

Once generated, switch fabric 105 routes a first copy of the data packet to port 109 and a second copy of the data packet to port 111 (step 219). In response, ports 109 and 111 respectively transmit the first and second copies of the data packet to peripherals 125 and 127.

Advantageously, methods 200 and 210 provide techniques for handling multicast and broadcast traffic within a configurable packet switch. As a result, methods 200 and 210 provide techniques for delivering data packets to multiple recipients in tandem.

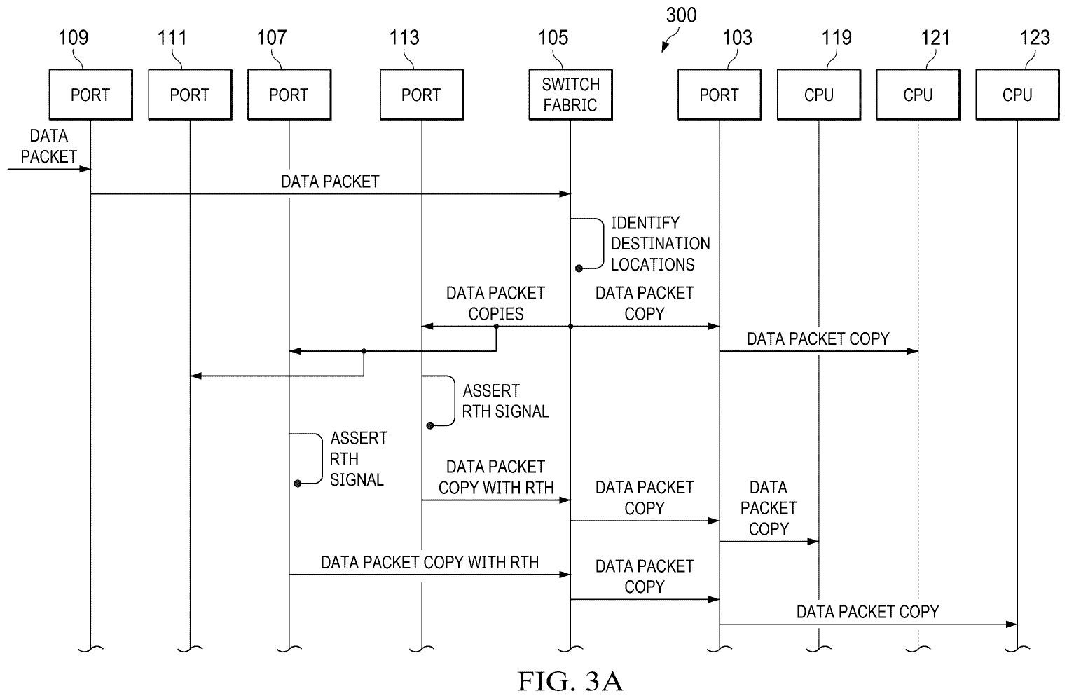

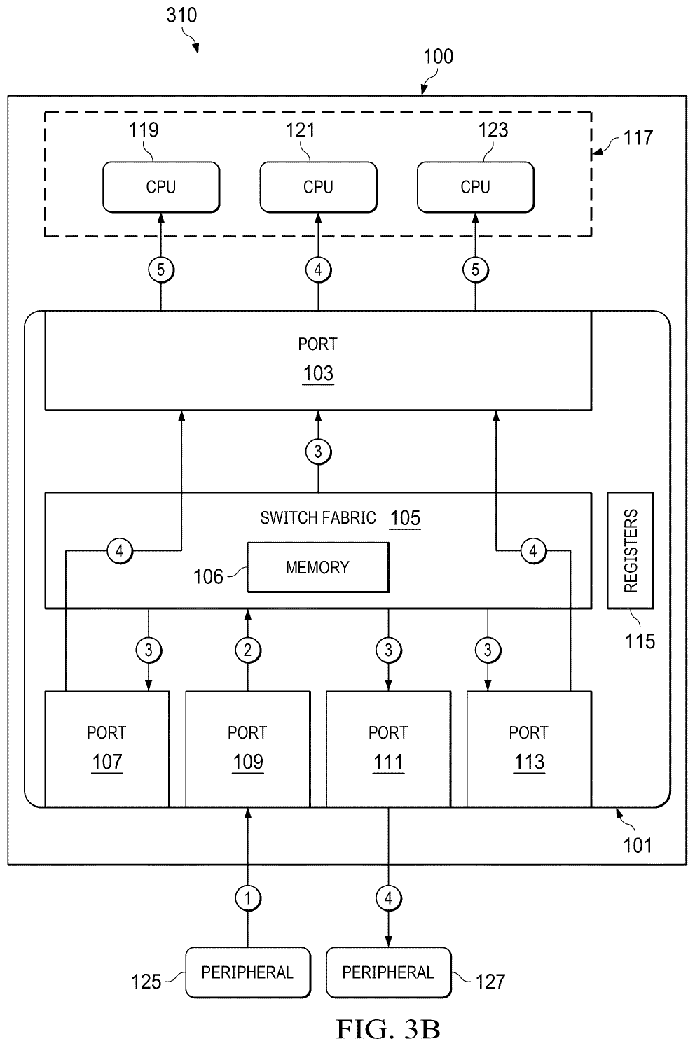

FIG. 3A illustrates sequence diagram 300 in an implementation. Sequence diagram 300 is representative of an operational sequence for handling broadcast traffic with respect to the elements of FIG. 1. In an implementation, sequence diagram 300 depicts an operational sequence for transmitting broadcast traffic that originated from a secondary device. Sequence diagram 300 includes port 109, port 111, port 107, port 113, switch fabric 105, host port 103, and CPUs 119, 121, and 123.

To begin, port 109 receives a data packet from peripheral 125, and transmits the data packet to switch fabric 105. In response, switch fabric 105 analyzes the identifier of the data packet to determine if the data packet includes unicast, multicast, or broadcast traffic. For example, switch fabric 105 may utilize the look-up table stored by memory 106 to determine that the intended recipient ports for routing the data packet include ports 103, 107, 111, and 113. As a result, switch fabric 105 classifies the data packet as broadcast traffic and generates four copies of the data packet.

Next, switch fabric 105 routes a first copy of the data packet to host port 103, a second copy of the data packet to port 107, a third copy of the data packet to port 111, and a fourth copy of the data packet to port 113. In response, host port 103 transmits the first copy of the data packet to CPU 121, and port 111 transmits the third copy of the data packet to peripheral 127. Additionally, ports 107 and 113 assert the RTH signal and transmit the copies of the data packet back to switch fabric 105. In response, switch fabric 105 bypasses the switch routing logic and routes the second and fourth copies of the data packet directly to host port 103.

In an implementation, when routing the second and fourth copies of the data packet directly to host port 103, switch fabric 105 appends metadata to the second and fourth copies of the data packet. For example, switch fabric 105 may access registers 115 and append the programmable attribute corresponding to port 107 as metadata to the second copy of the data packet. Similarly, switch fabric 105 may append the programmable attribute corresponding to port 113 as metadata to the fourth copy of the data packet.

In an implementation, the metadata is appended to the copies of the data packet via a sideband signal. For example, when switch fabric 105 is routing the second copy of the data packet directly to host port 103, switch fabric 105 may also route a sideband signal containing the corresponding metadata to host port 103. Similarly, when switch fabric 105 is routing the fourth copy of the data packet directly to host port 103, switch fabric 105 may also route a sideband signal containing the corresponding metadata to host port 103. Once received, host port 103 may analyze the metadata of the sideband signals to determine that the second copy of the data packet is intended for CPU 119 based on the second copy being reflected by port 107, while the fourth copy of the data packet is intended for CPU 123 based on the fourth copy being reflected by port 113. Host port 103 may then transmit the second copy of the data packet to CPU 119 and transmit the fourth copy of the data packet to CPU 123.

FIG. 3B illustrates operational scenario 310 in an implementation. Operational scenario 310 is representative of an operational scenario for handling broadcast traffic with respect to the elements of FIG. 1. More specifically, operational scenario 310 depicts a scenario for transmitting broadcast traffic that originated from a secondary device. Operational scenario 310 includes system 100, and peripherals 125 and 127.

To begin, port 109 receives a data packet from peripheral 125, as indicated by the arrow labeled “1”. Once received, port 109 transmits the data packet to switch fabric 105, as indicated by the arrow labeled “2”. Next, switch fabric 105 analyzes the contents of the data packet to determine whether the data packet includes unicast, multicast, or broadcast traffic. For example, switch fabric 105 may compare the identifier of the data packet to the look-up table stored by memory 106 to determine that the intended recipient ports for the data packet include ports 103, 107, 111, and 113. As a result, switch fabric 105 classifies the data packet as broadcast traffic and generates four copies of the data packet.

Next, switch fabric 105 routes a first copy of the data packet to host port 103, a second copy of the data packet to port 107, a third copy of the data packet to port 111, and a fourth copy of the data packet to port 113, as indicated by the arrows labeled “3”. In response, host port 103 transmits the first copy of the data packet to CPU 121, and port 111 transmits the third copy of the data packet to peripheral 127, as indicated by the arrows labeled “4”. Additionally, ports 107 and 113 transmit the copies of the data packet back to switch fabric 105 with an indication to route the data packets to host port 103, as indicated by the arrows labeled “4”. For example, the indication may include an RTH signal which causes switch fabric 105 to bypass the switch routing logic and route the copies of the data packet directly to host port 103.

In an implementation, when routing the second and fourth copies of the data packet directly to host port 103, switch fabric 105 appends metadata to the second and fourth copies of the data packet via sideband signals. For example, switch fabric 105 may access registers 115 and append the programmable attribute corresponding to port 107 as a sideband signal to the second copy of the data packet. Similarly, switch fabric 105 may append the programmable attribute corresponding to port 113 as a sideband signal to the fourth copy of the data packet. Once appended, switch fabric 105 may route the second and fourth copies of the data packet directly to host port 103, along with the corresponding sideband signals. In response, host port 103 may analyze the programmable attributes of the sideband signals to determine that the second copy of the data packet is intended for CPU 119, while the fourth copy of the data packet is intended for CPU 123. Host port 103 may then transmit the second copy of the data packet to CPU 119 based on the second copy being reflected by port 107 and transmit the fourth copy of the data packet to CPU 123 based on the fourth copy being reflected by port 113, as indicated by the arrows labeled “5”.

It should be noted that ports 103 and 111 operate in tandem when transmitting a broadcast or multicast data packet. For example, host port 103 may transmit the first copy of the data packet to CPU 121, the second copy of the data packet to CPU 119, and the fourth copy of the data packet to CPU 123 in tandem. Meanwhile, port 111 may transmit the third copy of the data packet to peripheral 127 in tandem with host port 103 transmitting the first, second, and fourth copies of the data packet to CPUs 119, 121, and 123.

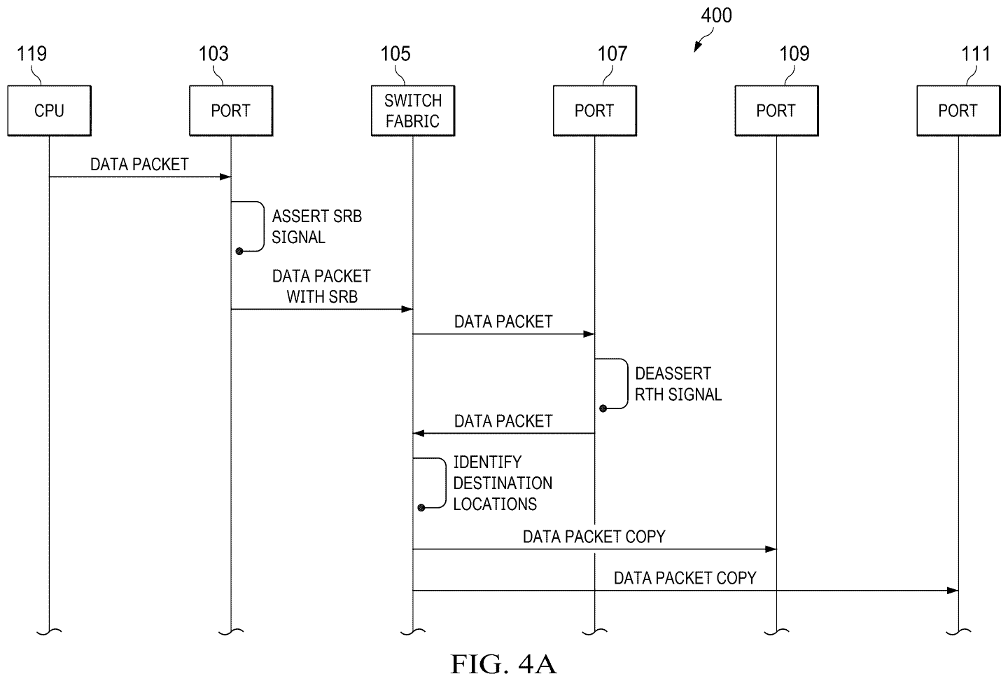

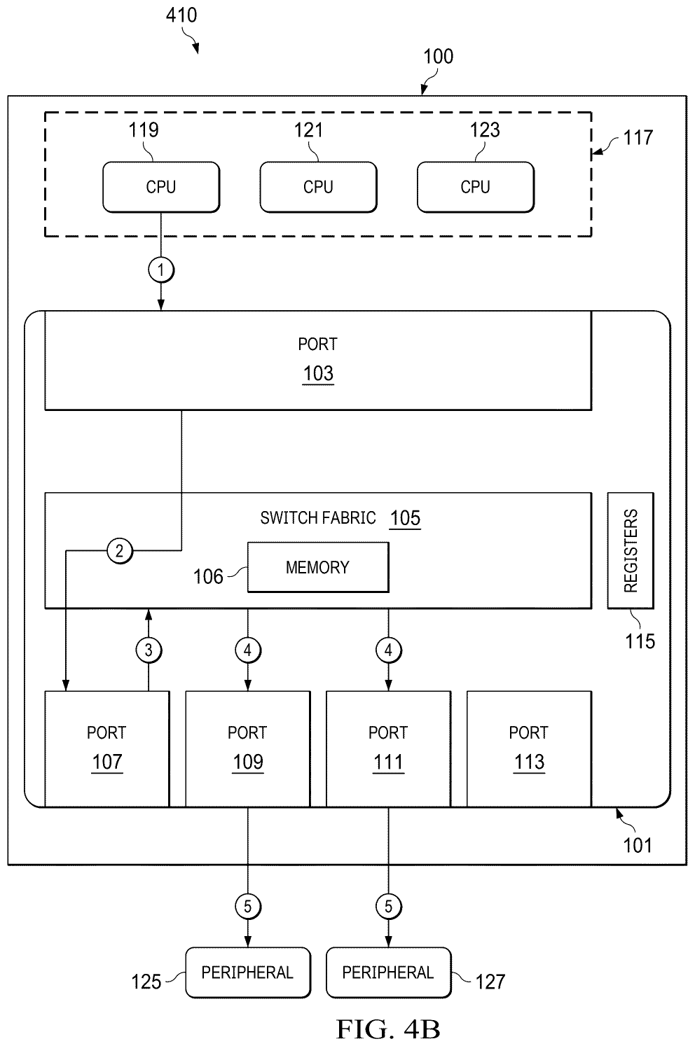

FIG. 4A illustrates sequence diagram 400 in an implementation. Sequence diagram 400 is representative of an operational sequence for handling multicast traffic with respect to the elements of FIG. 1. In an implementation, sequence diagram 400 depicts an operational sequence for transmitting multicast traffic that originated from the primary device. Sequence diagram 400 includes CPU 119, host port 103, switch fabric 105, host port 103, port 109, and port 111.

To begin, CPU 119 transmits a data packet to host port 103, and in response, host port 103 analyzes the data path metadata of the data packet to determine the intended recipient ports for the data packet. For example, host port 103 may compare the data path metadata to the programmable parameters stored by registers 115 to determine that the data packet was transmitted across the data path that corresponds to CPU 119. In response, host port 103 may determine that the data packet is intended for port 107. Once determined, host port 103 asserts the SRB signal to cause switch fabric 105 to directly route the data packet to port 107. In an implementation, the SRB signal is asserted via a collection of wires which connects host port 103 to switch fabric 105. For example, when transmitting the data packet to switch fabric 105, host port 103 may cause the collection of wires to form a binary value that corresponds to the index of port 107 and serves as the asserted SRB signal. As a result, host port 103 causes switch fabric 105 to bypass the switch routing logic and route the data packet from host port 103 directly to port 107.

Next, port 107 determines that an SRB signal has been asserted, and in response, deasserts the RTH signal and transmits the data packet back to switch fabric 105. Switch fabric 105 then analyzes the identifier of the data packet to determine if the data packet includes unicast, multicast, or broadcast traffic. For example, switch fabric 105 may utilize the look-up table stored by memory 106 to determine that the identifier of the data packet indicates that the intended recipient ports for the data packet include ports 109 and 111, and in response, classify the data packet as multicast traffic. Next, switch fabric 105 generates two copies of the data packet and routes a first copy of the data packet to port 109 and routes a second copy of the data packet to port 111. In response, ports 109 and 111 respectively transmit the first and second copies of the data packet to peripherals 125 and 127.

FIG. 4B illustrates operational scenario 410 in an implementation. Operational scenario 410 is representative of an operational scenario for handling multicast traffic with respect to the elements of FIG. 1. More specifically, operational scenario 410 depicts a scenario for transmitting multicast traffic originated by the primary device. Operational scenario 410 includes system 100, and peripherals 125 and 127.

To begin, host port 103 receives a data packet from CPU 119, as indicated by the arrow labeled “1”. Once received, host port 103 analyzes the data path metadata of the data packet to determine the intended recipient ports for the data packet. For example, host port 103 may compare the data path metadata to the programmable parameters stored by registers 115 to determine that the data packet was transmitted across the data path that corresponds to CPU 119, and in response, determine that the data packet is intended for port 107. Once determined, host port 103 asserts the SRB signal to cause switch fabric 105 to directly route the data packet to port 107. For example, when transmitting the data packet to switch fabric 105, host port 103 may cause a collection of wires which connects host port 103 to switch fabric 105 to form a binary value that corresponds to the index of port 107, and serves as the asserted SRB signal. As a result, host port 103 causes switch fabric 105 to bypass the switch routing logic and route the data packet from host port 103 directly to port 107, as indicated by the arrow labeled “2”.

Next, port 107 determines that the SRB signal has been asserted, and in response, deasserts the RTH signal and transmits the data packet back to switch fabric 105 as indicated by the arrow labeled “3”. In response, switch fabric 105 analyzes the contents of the data packet via the switch routing logic to determine whether the data packet includes unicast, multicast, or broadcast traffic. For example, switch fabric 105 may utilize the look-up table stored by memory 106 to determine that the identifier of the data packet includes multicast traffic intended for ports 109 and 111.

Once determined, switch fabric 105 generates two copies of the data packet and routes the first copy of data packet to port 109 and the second copy of the data packet to port 111, as indicated by the arrows labeled “4”. In response, ports 109 transmits the first copy of the data packet to peripheral 125 and port 111 transmits the second copy of the data packet to peripheral 127.

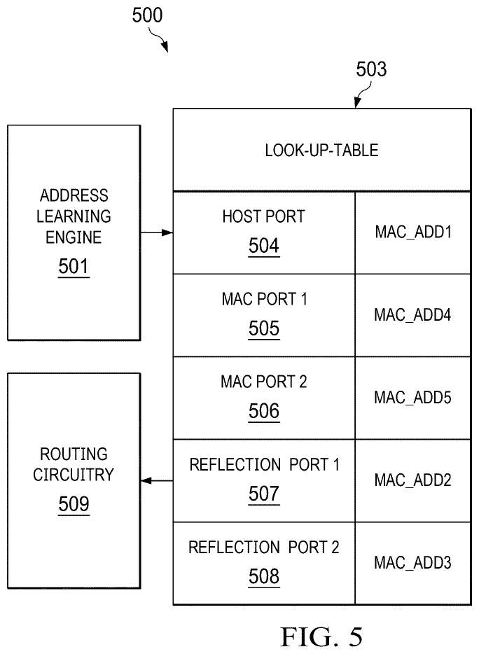

FIG. 5 illustrates switch fabric 500 in an implementation. Switch fabric 500 is representative of circuitry for routing data packets within the context of a packet switch. For example, switch fabric 500 may represent switch fabric 105 of FIG. 1. Switch fabric 500 includes address learning engine 501, look-up table 503, and routing circuitry 509.

Address learning engine 501 is representative of circuitry for analyzing the identifier of a data packet. For example, address learning engine 501 may be representative of an MCU, ASIC, CPU, or another GPP or the like. In an implementation, address learning engine 501 is configured to populate look-up table 503 based on the identifier of a data packet. The identifier of a data packet refers to a unique value, or set of values, which specifies the source and recipient(s) for the data packet. For example, the identifier of the data packet may include the source and recipient MAC addresses, IP addresses, and/or VLAN IDs.

During operation, when switch fabric 500 receives a data packet, address learning engine 501 may analyze the identifier of the data packet to determine the port that is associated with the source of the data packet. For example, within the context of FIG. 1, host port 103 may transmit a data packet that was originated by CPU 121 to switch fabric 500, and in response, address learning engine 501 may analyze the identifier of the data packet to determine the MAC address for the data packet. Address learning engine 501 may then populate look-up table 503 to associate host port 103 with the MAC address contained in the data packet that originated from CPU 121.

Look-up table 503 is representative of a table that correlates the ports of a packet switch to the network endpoints that are connected to the packet switch. For example, within the context of FIG. 1, look-up table 503 is stored in memory 106 and correlates the MAC address contained in the data packets transmitted from CPU 119 with port 107, the MAC address contained in the data packets transmitted from CPU 121 with host port 103, the MAC address contained in the data packets transmitted from CPU 123 with port 113, the MAC address contained in the data packets transmitted from peripheral 125 with port 109, and the MAC address contained in the data packets transmitted from peripheral 127 with port 111. Look-up table 503 includes, but is not limited to, entries 504, 505, 506, 507, and 508.

Entries 504-508 are representative of entries which store data for correlating a port to a MAC address of an associated network endpoint. For example, entry 504 may correlate the host port of a packet switch to the MAC address of a first network endpoint (MAC_ADDR1), entry 505 may correlate a first MAC port of the packet switch to the MAC address of a fourth network endpoint (MAC_ADDR4), entry 506 may correlate a second MAC port of the packet switch to the MAC address of a fifth network endpoint (MAC_ADDR5), entry 507 may correlate a first reflection port of the packet switch to the MAC address of a second network endpoint (MAC_ADDR2), and entry 508 may correlate a second reflection port of the packet switch to the MAC address of a third network endpoint (MAC_ADDR3). It should be noted that a network endpoint may refer to a secondary device or a module of the primary device. For example, within the context of FIG. 1, the network endpoints include peripherals 125 and 127, as well as CPUs 119, 121, and 123. During operation, routing circuitry 509 may reference entries 504-508 to determine the appropriate port or ports for routing a data packet.

Routing circuitry 509 is representative of the circuitry that is responsible for routing the data packets. For example, routing circuitry 509 may include a crossbar switch that provides pathways between the ports of a packet switch. In an implementation, routing circuitry 509 implements switch routing logic to determine the appropriate port or ports for routing a data packet. For example, the switch routing logic may be implemented in the context of hardware, software, firmware, or a combination thereof, to cause routing circuitry 509 to examine the identifier of the data packet to determine the intended recipient ports for the data packet. In an implementation, to determine the intended recipient ports for routing a data packet, the switch routing logic causes routing circuitry 509 to reference look-up table 503. For example, after receiving a data packet from a first port, the switch routing logic may cause routing circuitry 509 to analyze the identifier of the data packet to identify the recipient MAC addresses associated with the data packet. The switch routing logic may then cause routing circuitry 509 to reference look-up table 503 to determine the port or ports that are associated with the identified recipient MAC addresses. Once determined, the switch routing logic causes routing circuitry 509 to route the data packet from the first port, to the port or ports that are associated with the identified MAC addresses.

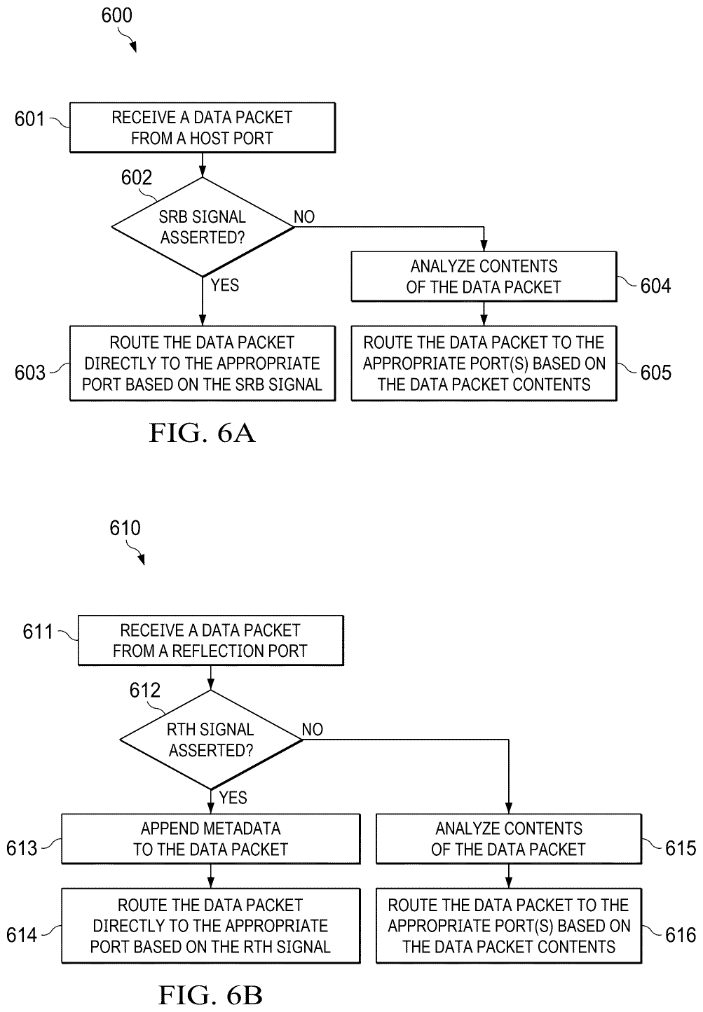

FIGS. 6A and 6B respectively illustrate switch fabric process 600 and switch fabric process 610 in an implementation. Switch fabric processes 600 and 610 are representative of techniques for routing data packets via a switch fabric. More specifically, switch fabric process 600 provides a technique for routing a data packet that was received from a host port, while switch fabric process 610 provides a technique for routing a data packet that was received from a reflection port. Switch fabric processes 600 and 610 may be implemented in the context of hardware, firmware, or software to cause a system to operate as follows, referring parenthetically to the steps in FIGS. 6A and 6B. For the purposes of explanation, switch fabric processes 600 and 610 will be explained with respect to the elements of FIG. 5. This is not meant to limit the applications of switch fabric processes 600 and 610, but rather to provide an example.

To begin switch fabric process 600, routing circuitry 509 receives a data packet from a host port (step 601). For example, within the context of FIG. 1, routing circuitry 509 may receive a data packet from host port 103. Next, routing circuitry 509 determines if an SRB signal has been asserted by the host port (step 602). For example, within the context of FIG. 1, routing circuitry 509 may determine if host port 103 provided switch fabric 500 with a binary value that corresponds to the index of a reflection port via a collection of wires which connects host port 103 to switch fabric 500. If routing circuitry 509 determines that an SRB signal has been asserted by the host port, then routing circuitry 509 bypasses the switch routing logic and routes the data packet directly to the reflection port with the corresponding index (step 603). Alternatively, if routing circuitry 509 determines the SRB signal has not been asserted, then routing circuitry 509 executes the switch routing logic, and in response, analyzes the contents of the data packet (step 604).

For example, the switch routing logic may first cause routing circuitry 509 to analyze the identifier of the data packet to identify the recipient MAC addresses associated with the data packet. The switch routing logic may then cause routing circuitry 509 to reference look-up table 503 to determine the port or ports that are associated with the identified MAC addresses. Once determined, the switch routing logic causes routing circuitry 509 to route the data packet to the port or ports that are associated with the identified MAC addresses (step 605).

To begin switch fabric process 610, routing circuitry 509 receives a data packet from a reflection port (step 611). For example, within the context of FIG. 1, routing circuitry 509 may receive a data packet from port 107. Next, routing circuitry 509 determines if an RTH signal has been asserted by the reflection port (step 612).

If routing circuitry 509 determines that an RTH signal has been asserted, then routing circuitry 509 appends metadata to the data packet (step 613). The metadata is representative of a programmable attribute that specifies the intended recipients for the data packet. For example, within the context of FIG. 1, if the data packet was transmitted by port 107, then routing circuitry 509 may access register 115 and append the metadata corresponding to port 107 to the data packet. In an implementation, routing circuitry 509 appends the metadata via a sideband signal. For example, when routing the data packet to the host port, routing circuitry 509 may also route the sideband signal containing the corresponding metadata to the host port (step 614).

Alternatively, if routing circuitry 509 determines that the RTH signal has not been asserted, then routing circuitry 509 executes the switch routing logic, and in response, analyzes the contents of the data packet (step 615). For example, the switch routing logic may first cause routing circuitry 509 to analyze the identifier of the data packet to identify the recipient MAC addresses associated with the data packet. The switch routing logic may then cause routing circuitry 509 to reference look-up table 503 to determine the port or ports that are associated with the identified MAC addresses. Once determined, the switch routing logic causes routing circuitry 509 to route the data packet to the port or ports that are associated with the identified MAC addresses (step 605).

It should be noted that the operations performed by switch fabric process 610, when the RTH signal is not asserted (i.e., steps 611, 612, 615, and 616), also applies when switch fabric 105 receives a data packet from a MAC port (e.g., ports 109 or 111).

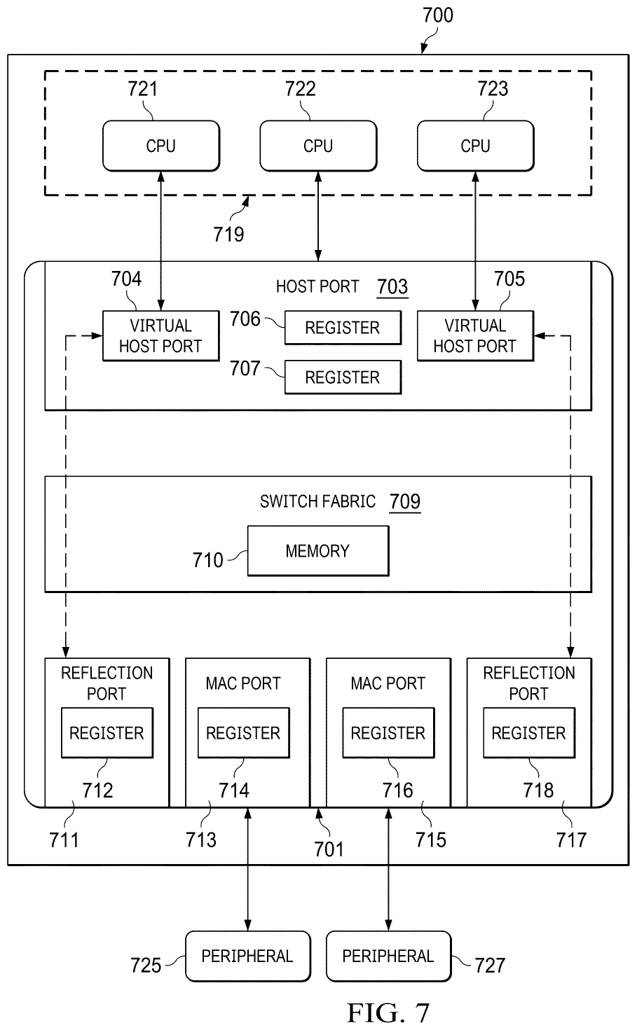

FIG. 7 illustrates system 700 in an implementation. System 700 is representative of an exemplary system which utilizes a packet switch for facilitating communication between multiple modules of primary device and multiple secondary devices. For example, system 700 may depict an ethernet switch in various system environments, such as an automotive application, industrial application, data center application, or an embedded networking application. System 700 includes, but is not limited to, packet switch 701 and primary device 719, and is coupled to peripheral 725 and peripheral 727.

Packet switch 701 is a networking device, such as an ethernet switch, that facilitates the transmission of data packets across various network endpoints. For example, packet switch 701 may represent packet switch 101 of FIG. 1. In an implementation, packet switch 701 facilitates the transmission of data packets between the modules of a primary device and multiple secondary devices. The primary device includes the host device of system 700, and the modules of the primary device include the processing cores of the host device. The multiple secondary devices describe the various peripherals of system 700. For example, the primary device may include a processing core set 719, housing CPUs 721, 722, and 723, while the secondary devices include peripherals 725 and 727 (e.g., peripherals 125 and 127). Packet switch 701 includes host port 703, reflection ports 711 and 717, MAC ports 713 and 715, and switch fabric 709.

Host port 703 is representative of a networking port (e.g., host port 103) that connects packet switch 701 to the modules of a primary device. For example, host port 703 may connect packet switch 701 to CPUs 721, 722, and 723 of primary device 719. Host port 703 includes, but is not limited to, virtual host ports (VHPs) 704 and 705, and registers 706 and 707.

VHPs 704 and 705 are representative of logically defined networking ports that function as host ports. A logically defined networking port refers to a port that is implemented in the hardware of one or more other ports. For example, VHP 704 may be implemented within the hardware of host port 703 and reflection port 711. Similarly, VHP 705 may be implemented within the hardware of host port 703 and reflection port 717. In an implementation, VHPs 704 and 705 serve as dedicated data paths for connecting a processing core to a corresponding reflection port. For example, VHP 704 may serve as a data path for connecting reflection port 711 to CPU 721, while VHP 705 serves as a data path for connecting reflection port 717 to CPU 723.

In an implementation, when a CPU transmits a data packet to host port 703 over a data path, the CPU also transmits data path metadata to host port 703. The data path metadata refers to a parameter which identifies the path taken to transmit the data packet from primary device 719 to host port 703. For example, the data path metadata may indicate that a data packet was transmitted from CPU 119 to VHP 704. In an implementation, when host port 703 receives a data packet from a CPU of primary device 719, host port 703 compares the data path metadata of the data packet to the data stored by registers 706 and 707.

Registers 706 and 707 are representative of registers that store programmable parameters for associating a VHP with a specific reflection port. For example, the programmable parameters stored by registers 706 and 707 may include transmit-data-path flow configurable (TDPF-CFG) values. The TDPF-CFG values include data which links a VHP to a specific reflection port. For example, the TDPF-CFG value of register 706 may link VHP 704 to reflection port 711. Similarly, the TDPF-CFG value of register 707 may link VHP 705 to reflection port 717.

It should be noted that, although illustrated to include two registers, host port 703 includes a register for each reflection/MAC port of the packet switch. For example, within the context of packet switch 701, host port 703 includes a first register corresponding to reflection port 711 (i.e., register 706), a second register corresponding to MAC port 713, a third register corresponding to MAC port 715, and a fourth register corresponding to reflection port 717 (i.e., register 707), but for the purposes of explanation, only register 706 and 707 will be discussed herein. It should also be noted that, although registers 706 and 707 are depicted as being part of host port 703, this may not be accurate. Instead, registers 706 and 707 may reside within a memory that is accessible to host port 703.

During operation, when host port 703 receives a data packet from primary device 719, host port 703 compares the data path metadata of the data packet to the TDPF-CFG values stored by registers 706 and 707. As a result, host port 703 determines if the data packet is intended to be transmitted to reflection port 711 or reflection port 717. If the data path metadata matches the TDPF-CFG value stored by register 706, then host port 703 determines that the data packet is intended to be transmitted to reflection port 711. Similarly, if the data path metadata matches the TDPF-CFG value stored by register 707, then host port 703 determines that the data packet is intended to be transmitted to reflection port 717. Alternatively, if the data path metadata does not match the values stored by the registers of host port 703, then host port 703 transmits the data packet to switch fabric 709.

In an implementation, if host port 703 determines that a data packet is intended for a reflection port, then host port 703 asserts an SRB signal to the data packet. The SRB signal is a signal which causes switch fabric 709 to bypass its routing logic and route the data packet directly to the appropriate reflection port. In an implementation, host port 703 asserts the SRB signal via a collection of wires which connects host port 703 to switch fabric 709. For example, when transmitting the data packet to switch fabric 709, host port 703 may cause the collection of wires to form a binary value that corresponds to the index of a reflection port and serves as the asserted SRB signal.

Reflection ports 711 and 717 are representative of networking ports (e.g., ports 107 and 113) that serve as host ports for a respective processing core. For example, reflection port 711 may serve as the host port for CPU 721, while reflection port 717 serves as the host port for CPU 723. During operation, CPUs 721 and 723 respectively transmit data packets across VHPs 704 and 705, and in response, host port 703 determines to respectively transmit the data packets directly to reflection ports 711 and 717 via switch fabric 709. It should be noted that the data packets are received by host port 703 on the physical level but are sent across the dedicated data paths which act as VHPs 704 and 705. Reflection ports 711 and 717 respectively include registers 712 and 718.

Registers 712 and 718 are representative of registers which respectively store programmable attributes for reflection ports 711 and 717. The programmable attributes stored by registers 712 and 718 describe metadata which tie a specific reflection port to a specific VHP, and in turn, a specific processing core. For example, the programmable attribute may include a receive-data-path flow configurable (RDPF-CFG) value. The RDPF-CFG value includes data which links a reflection port to a specific virtual host port. For example, the RDPF-CFG value of register 712 may link reflection port 711 to VHP 704, and in turn CPU 721. Similarly, the RDPF-CFG value of register 718 may link reflection port 717 to VHP 705, and in turn CPU 723.

During operation, reflection ports 711 and 717 respectively receive data packets destined for CPUs 721 and 723, and in response, respectively transmit the data packets directly to VHPs 704 and 705 via switch fabric 709. In an implementation, to transmit a data packet directly to a VHP, reflection ports 711 and 717 assert an RTH signal with the data packet.

MAC ports 713 and 715 are representative of network ports (e.g., port 109 and 111) that connect packet switch 701 to the peripherals (i.e., peripherals 725 and 727) of system 700. For example, if system 700 depicts an industrial setting such as a manufacturing plant, then peripherals 725 and 727 may include programmable logic controllers (PLCs), mini-PLCs, remote Input/Output (I/O) nodes, or other devices of the like for controlling machinery, monitoring sensors, and managing automation tasks. MAC ports 713 and 715 include registers 714 and 716.

In an implementation, MAC ports 713 and 715 can be converted into reflection ports, and reflection ports 711 and 717 can be converted into MAC ports. For example, MAC ports 713 and 715, as well as reflection ports 711 and 717 may either operate under a normal mode or a reflection mode. When a port is operating under the normal mode, the RDPF-CFG value of its register is disabled. Alternatively, when a port is operating under the reflection mode, the RDPF-CFG value of its register is enabled. As a result, packet switch 701 depicts a configurable packet switch that may be adjusted based on the intended application.

It should be noted that, when a reflection port is converted into a MAC port, the RDPF-CFG value of its register is disabled, and the corresponding VHP may be eliminated. For example, if reflection port 711 is converted into a MAC port, then the RDPF-CFG value stored by register 712 is disabled, and VHP 704 may be removed from host port 703. Alternatively, when a MAC port is converted into a reflection port, the RDPF-CFG value of its register is enabled. For example, if MAC port 713 is converted into a reflection port that corresponds to a new VHP of host port 703, then register 714 may be populated with an RDPF-CFG value that links the newly converted reflection port to the new VHP. Additionally, a second register is populated with the TDPF-CFG value for associating the new VHP to the newly converted reflection port.

It should also be noted that, although registers 712, 714, 716, and 718 are depicted as being part of reflection port 711, MAC port 713, MAC port 715, and reflection port 717 respectively, this may not be accurate. Instead, registers 712, 714, 716, and 718 may reside within a memory that is accessible to switch fabric 709.

Switch fabric 709 represents circuitry (e.g., switch fabric 105 or switch fabric 500) that is responsible for determining the appropriate ports for routing a data packet and includes the necessary pathways for routing the data packet between said ports. For example, switch fabric 709 may include an ASIC, FPGA, MCU, or another device of the like which includes pathways for routing data packets between the ports of packet switch 701. In an implementation, switch fabric 709 includes logic for determining the appropriate pathways for routing received data packets. For example, switch fabric 709 may include switch routing logic, implemented in the context of software, hardware, firmware, or a combination thereof, that causes switch fabric 709 to classify a data packet as unicast, multicast, or broadcast traffic.

In an implementation, to classify a data packet as unicast, multicast, or broadcast traffic, switch fabric 709 analyzes the identifier for the data packet to determine the number of ports for routing the data packet. For example, switch fabric 709 may analyze the MAC addresses within the identifier for the data packet to determine if the data packet is intended for a single recipient port, multiple recipient ports, or every possible recipient port. If switch fabric 709 identifies a single recipient port within the identifier for the data packet, then switch fabric 709 classifies the data packet as unicast traffic. Alternatively, if switch fabric 709 identifies multiple recipient ports within the identifier for the data packet, then switch fabric 709 classifies the data packet as multicast traffic. Conversely, if switch fabric 709 identifies every possible recipient port within the identifier for the data packet, then switch fabric 709 classifies the data packet as broadcast traffic.

In an implementation, memory 710 of switch fabric 709 includes a look-up table (e.g., look-up table 503) for associating the MAC addresses of an identifier to specific ports of packet switch 701. For example, the look-up table may correlate the MAC address contained in the data packets transmitted from CPU 721 with reflection port 711, the MAC address contained in the data packets transmitted from CPU 722 with host port 703, the MAC address contained in the data packets transmitted from CPU 723 with reflection port 717, the MAC address contained in the data packets transmitted from peripheral 725 with MAC port 713, and the MAC address contained in the data packets transmitted from peripheral 727 with MAC port 715. During operation, switch fabric 709 may reference the look-up table of memory 710 to determine the appropriate port, or ports, for routing a data packet.

CPUs 721, 722, and 723 represent the processing cores (e.g., CPUs 119, 121, and 123) within the primary device (e.g., processing core set 719) of system 700. It should be noted that CPUs 721, 722, and 723 are not limited to traditional CPUs, and may instead represent other types of processing units, including DSPs, GPUs, FPGAs, MCUs, ASICs, or another GPP or the like, but for the purposes of explanation, CPUs will be discussed herein. Additionally, it may be appreciated that, although system 700 is illustrated to include primary device 719, primary device 719 may instead function as its own system. For example, packet switch 701 and primary device 719 may represent separate chips, rather than being incorporated within the same chip.

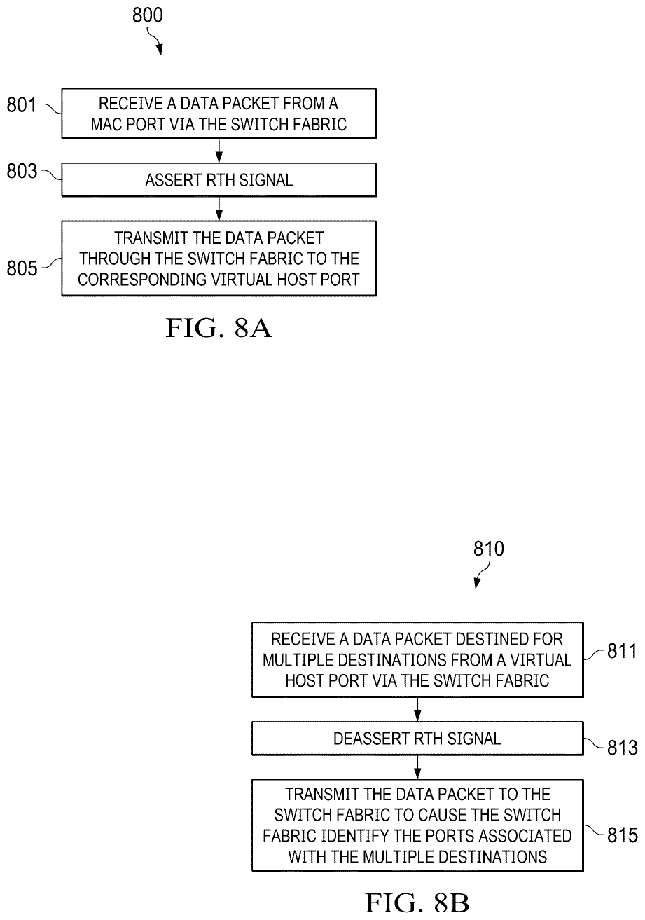

FIGS. 8A and 8B respectively illustrate reflection port process 800 and reflection port process 810 in an implementation. Reflection port processes 800 and 810 are representative of techniques for operating a reflection port. For example, reflection port processes 800 and 810 may provide techniques for operating port 107, port 109, port 111, port 113, reflection port 711, MAC port 713, MAC port 715, or reflection port 717. Reflection port processes 800 and 810 may be implemented in the context of hardware, firmware, or software to cause a reflection port to operate as follows, referring parenthetically to the steps in FIGS. 8A and 8B. For the purposes of explanation, reflection port processes 800 and 810 will be explained with respect to the elements of FIG. 7. This is not meant to limit the applications of reflection port processes 800 and 810, but rather to provide an example.

To begin reflection port process 800, reflection port 711 receives a data packet from MAC port 713 via switch fabric 709 (step 801). For example, peripheral 725 may transmit a data packet destined for CPU 721 to MAC port 713. Once received, MAC port 713 transmits the data packet to switch fabric 709. In response, switch fabric 709 executes the switch routing logic to determine that the data packet is destined for reflection port 711, and routes the data packet to reflection port 711. For example, switch fabric 709 may analyze the look-up table stored by memory 710 to determine that the identifier of the data packet is associated with reflection port 711.

Next, reflection port 711 determines that the data packet originated from a peripheral, and in response, asserts the RTH signal (step 803). In an implementation, to determine that the data packet originated from a peripheral, reflection port 711 checks if an SRB signal has been asserted. If an SRB signal has been asserted, then reflection port 711 determines that the data packet originated from a CPU of primary device 719. Alternatively, if an SRB signal has not been asserted, then reflection port 711 determines that the data packet originated from a peripheral. Once determined that the data packet originated from a peripheral, reflection port 711 asserts the RTH signal and transmits the data packet to switch fabric 709 to cause switch fabric 709 to bypass the switch routing logic and route the data packet directly to VHP 704 (step 805).

Now turning to FIG. 8B, to begin reflection port process 810, reflection port 711 receives a data packet from VHP 704 via switch fabric 709 (step 811). For example, CPU 721 may transmit a data packet destined for peripheral 727 to host port 703 via the data path which serves as VHP 704. In response, host port 703 compares the data path metadata of the data packet to the TDPF-CFG values stored by registers 706 and 707 and determines that the data packet was transmitted across VHP 704. Host port 703 may then assert the SRB signal via the collection of wires which connects host port 703 to switch fabric 709. For example, when transmitting the data packet to switch fabric 709, host port 703 may cause the collection of wires to provide a binary value corresponding to the index of reflection port 711 to switch fabric 709. In response, switch fabric 709 bypasses the switch routing logic and transmits the data packet directly to reflection port 711.

Next, reflection port 711 determines that an SRB signal has been asserted, and in response, deasserts the RTH signal (step 813). Once deasserted, reflection port 711 transmits the data packet to switch fabric 709 to cause switch fabric 709 to identify the ports for routing the data packet (step 815).

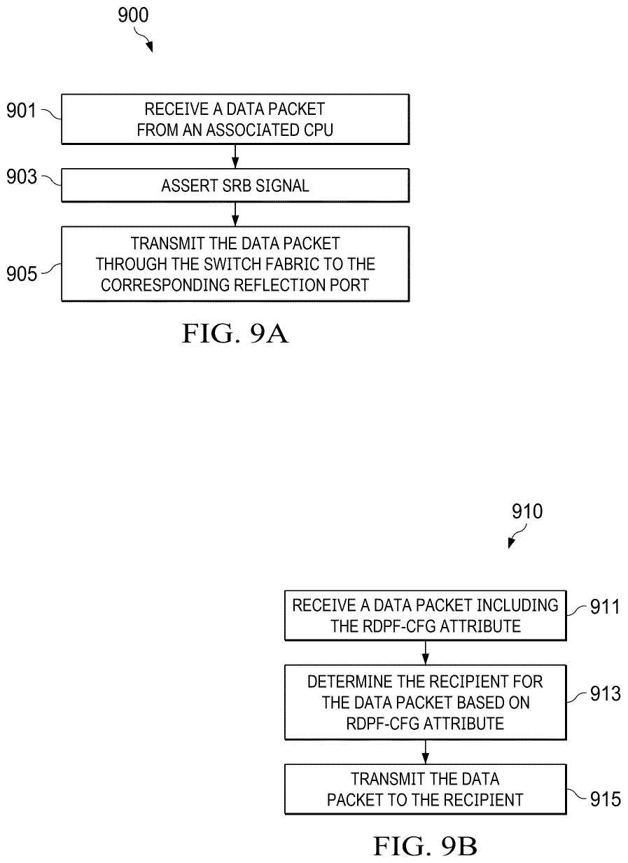

FIGS. 9A and 9B respectively illustrate VHP process 900 and VHP process 910 in an implementation. VHP processes 900 and 910 are representative of techniques for operating a virtual host port. For example, VHP processes 900 and 910 may provide techniques for operating host port 103, VHP 704, or VHP 705. VHP processes 900 and 910 may be implemented in the context of hardware, firmware, or software to cause a virtual host port to operate as follows, referring parenthetically to the steps in FIGS. 9A and 9B. For the purposes of explanation, VHP processes 900 and 910 will be explained with respect to the elements of FIG. 7. This is not meant to limit the applications of VHP process 900, but rather to provide an example.

To begin VHP process 900, VHP 704 receives a data packet from CPU 721 (step 901). For example, CPU 721 may transmit a data packet to host port 703 via the dedicated data path which serves as VHP 704. In response, host port 703 compares the data path metadata of the data packet to the TDPF-CFG values stored by registers 706 and 707 and determines that the data packet was transmitted across VHP 704. Host port 703 may then assert the SRB signal via the collection of wires which connects host port 703 to switch fabric 709 (step 903). For example, when transmitting the data packet to switch fabric 709, host port 703 may cause the collection of wires to provide a binary value corresponding to the index of reflection port 711 to switch fabric 709 (step 905). In response, switch fabric 709 bypasses the switch routing logic and transmits the data packet directly to reflection port 711.

Alternatively, to begin VHP process 910, VHP 704 receives a data packet and a sideband signal from switch fabric 709 (step 911). For example, reflection port 711 may receive a data packet that was originated by the peripheral coupled to MAC port 713, and in response, assert the RTH signal. Reflection port 711 may then transmit the data packet to switch fabric 709. In response, switch fabric 709 appends the RDPF-CFG value of register 712 as a sideband signal to the data packet and directly routes the data packet and the sideband signal to host port 703. Host port 703 then analyzes the sideband signal to determine that the data packet is intended for VHP 704, and in turn, CPU 721 (step 913). Once determined, host port 703 causes VHP 704 to transmit the data packet to CPU 721 (step 915).

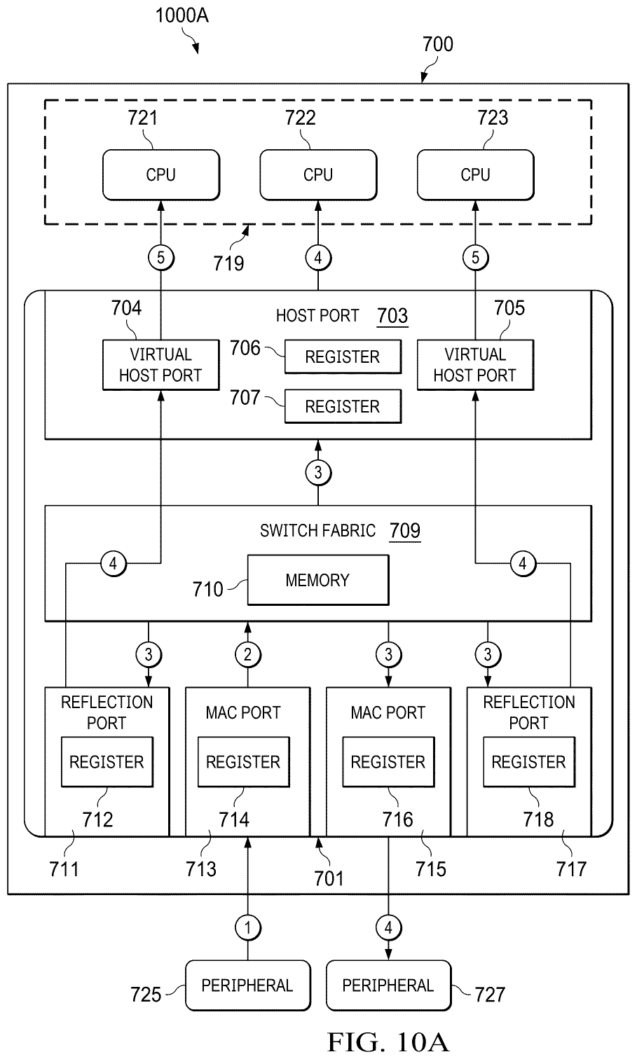

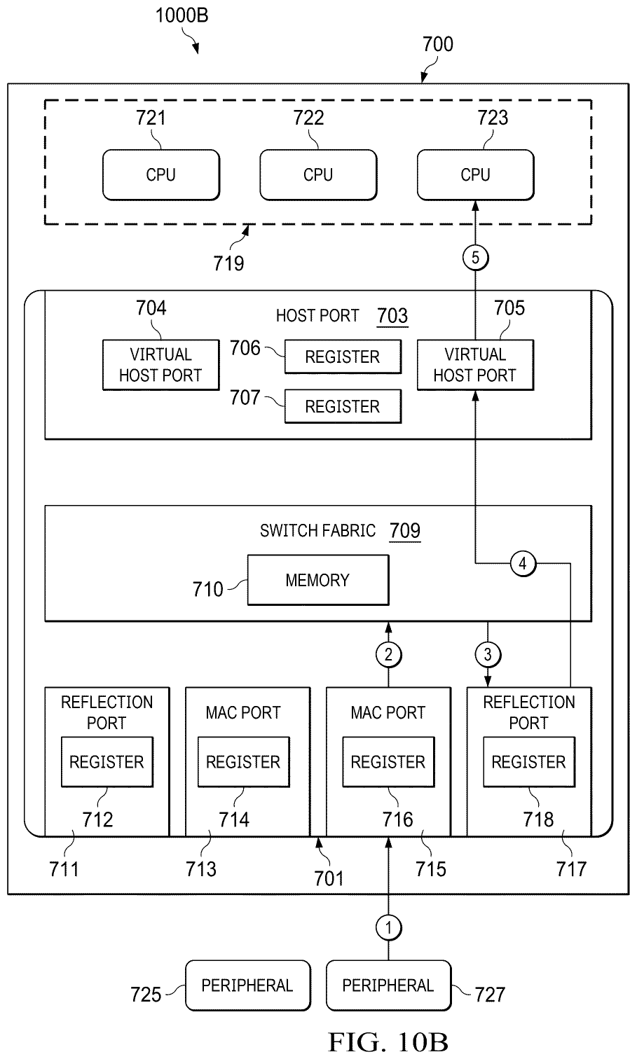

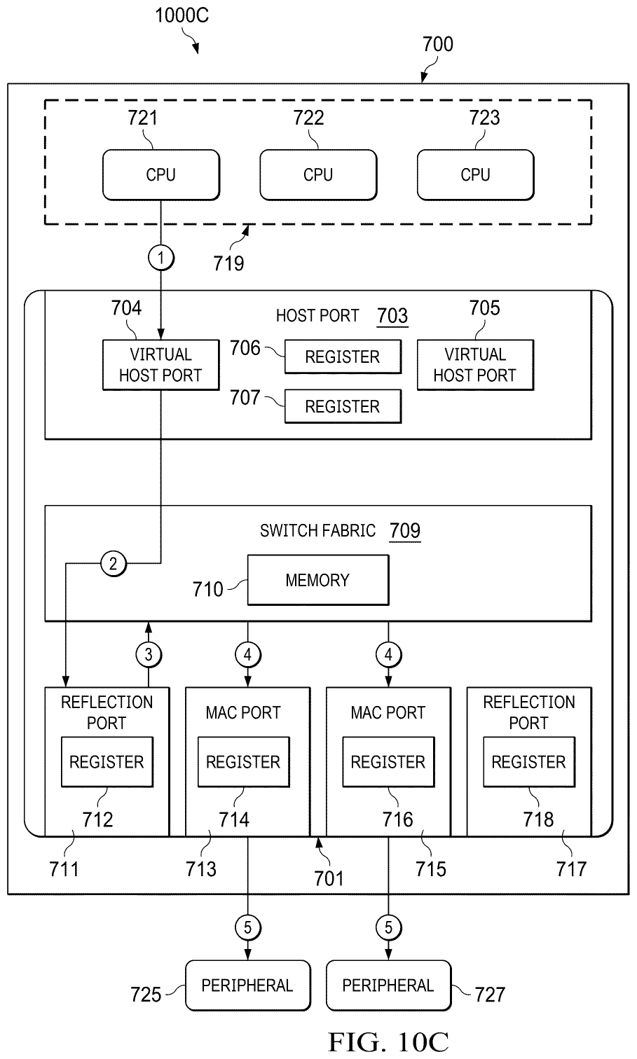

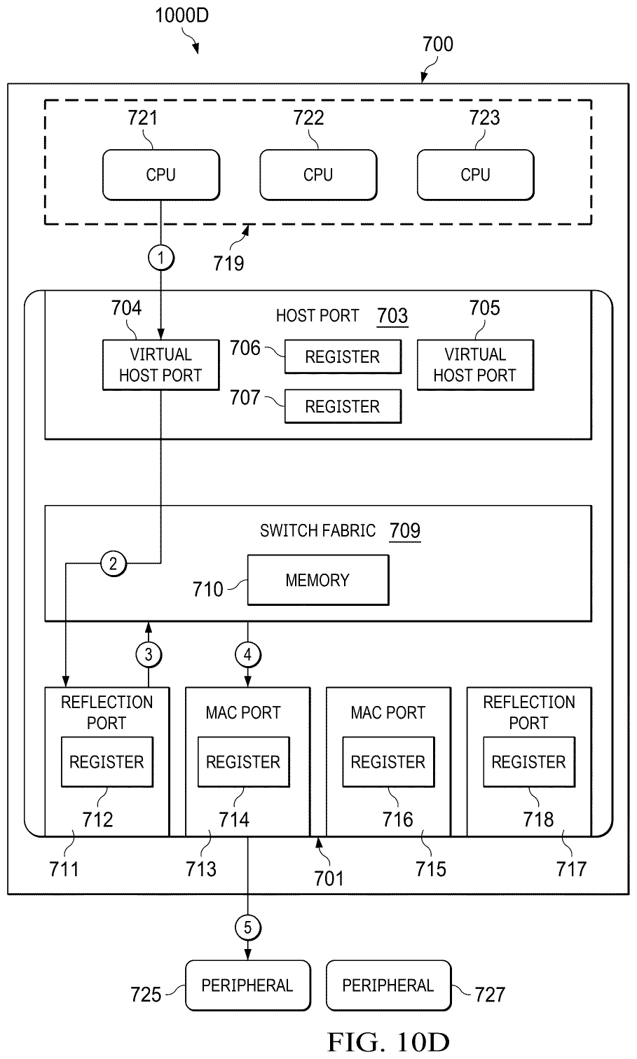

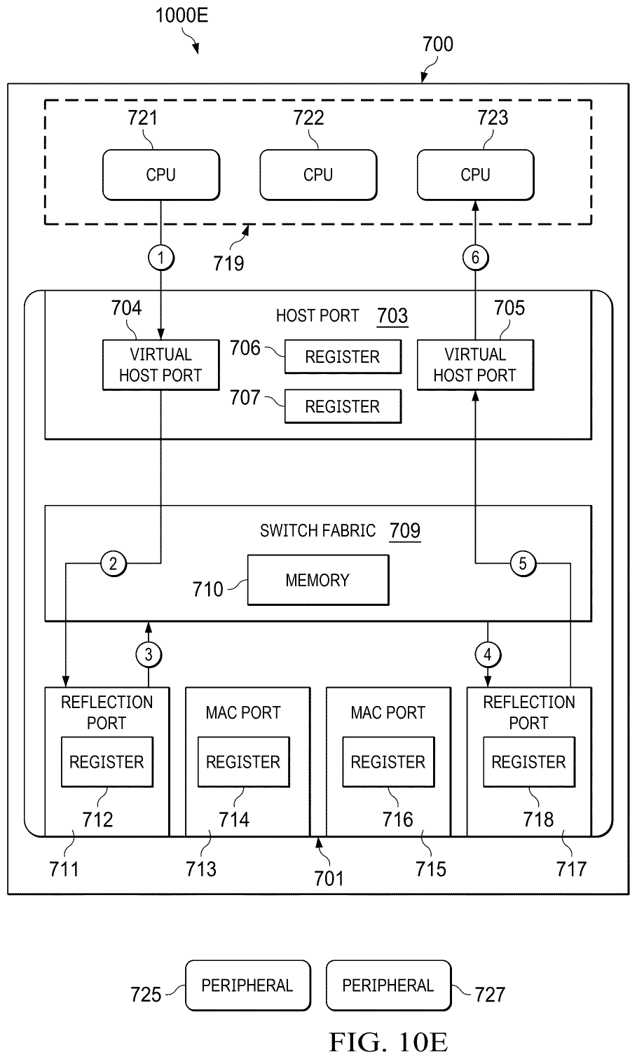

FIG. 10A illustrates scenario 1000A in an implementation. Scenario 1000A is representative of an operational scenario for handling broadcast traffic with respect to the elements of FIG. 7. More specifically, scenario 1000A depicts a scenario for transmitting broadcast traffic that originated from a secondary device. Scenario 1000A includes system 700, and peripherals 725 and 727 To begin, MAC port 713 receives a data packet peripheral 725, as indicated by the arrow labeled “1”. In response, MAC port 713 transmits the data packet to switch fabric 709, as indicated by the arrow labeled “2”. Next, switch fabric 709 executes the switch routing logic to classify the data packet as either unicast, multicast, or broadcast traffic. For example, the switch routing logic may cause switch fabric 709 to compare the identifier of the data packet to the look-up table stored by memory 710 to determine that the intended recipient ports for the data packet include host port 703, reflection port 711, MAC port 715, and reflection port 717. As a result, switch fabric 709 classifies the data packet as broadcast traffic. Once classified, switch fabric 709 generates four copies of the data packet and routes the first copy of the data packet to host port 703, the second copy of the data packet to reflection port 711, the third copy of the data packet to MAC port 715, and the fourth copy of the data packet to reflection port 717, as indicated by the arrows labeled “3”.

Once routed, host port 703 transmits the first copy of the data packet to CPU 722 and MAC port 715 transmits the third copy of the data packet to peripheral 727, as indicated by the arrows labeled “4”. Additionally, reflection ports 711 and 717 determine that the copies of the data packet originated from a peripheral, rather than a CPU of primary device 719, and in response, assert the RTH signal. For example, reflection ports 711 and 717 may note that an SRB signal was not asserted, and in response, assert the RTH signal. Once asserted, reflection ports 711 and 717 transmit the copies of the data packet back to switch fabric 709 to cause switch fabric 709 to bypass the switch routing logic and directly route the copies of the data packets to the appropriate VHP, as indicated by the arrows labeled “4”.

In an implementation, to determine the appropriate VHP for directly routing a data packet, switch fabric 709 generates sideband signals using the data stored by the register of the corresponding reflection port. For example, switch fabric 709 may generate a first sideband signal containing the RDPF-CFG of register 712, and a second sideband signal containing the RDPF-CFG of register 718. Once generated, switch fabric 709 may route the second copy of the data packet and the first sideband signal directly to host port 703. Switch fabric 709 may also route the fourth copy of the data packet and the second sideband signal directly to host port 703. In response, host port 703 may analyze the first and second sideband signals to determine that the second copy of the data packet is intended to be sent across VHP 704, while the fourth copy of the data packet is intended to be sent across VHP 705. Once determined, host port 703 may utilize VHP 704 and VHP 705 to respectively transmit the second and fourth copies of the data packet to CPUs 721 and 723, as indicated by the arrows labeled “5”. It should be noted that although the arrows are labeled sequentially, the actions which correspond with the arrows may occur in tandem. For example, host port 703, VHP 704, VHP 705, and MAC port 715 may transmit the data packet copies to the corresponding recipient in tandem.

FIG. 10B illustrates scenario 1000B in an implementation. Scenario 1000B is representative of an operational scenario for handling unicast traffic with respect to the elements of FIG. 7. More specifically, scenario 1000B depicts a scenario for transmitting unicast traffic originating from a secondary device. Scenario 1000B includes system 700, and peripherals 725 and 727.

To begin, MAC port 715 receives a data packet from peripheral 727, as indicated by the arrow labeled “1”. In response, MAC port 715 transmits the data packet to switch fabric 709, as indicated by the arrow labeled “2”. Next, switch fabric 709 executes the switch routing logic to classify the data packet as either unicast, multicast, or broadcast traffic. For example, the switch routing logic may cause switch fabric 709 to compare the identifier of the data packet to the look-up table stored by memory 710 to determine that the intended recipient port for the data packet includes reflection port 717. As a result, switch fabric 709 classifies the data packet as unicast traffic. Once classified, switch fabric 709 routes the data packet to reflection port 717, as indicated by the arrows labeled “3”.

Reflection port 717 may then determine that an SRB signal was not asserted, and in response, assert the RTH signal. Once asserted, reflection port 717 transmits the data packet back to switch fabric 709 to cause switch fabric 709 to bypass the switch routing logic and directly route the data packet to the appropriate VHP, as indicated by the arrows labeled “4”.

In an implementation, to determine the appropriate VHP for routing the data packet, switch fabric 709 appends metadata to the data packet. For example, switch fabric 709 may generate a sideband signal containing the RDPF-CFG of register 718 and route the data packet along with sideband signal directly to host port 703. In response, host port 703 may analyze the sideband signal to determine that the data packet is intended to be sent across VHP 705. Once determined, host port 703 may utilize VHP 705 to transmit the data packet to CPU 723, as indicated by the arrows labeled “5”.

FIG. 10C illustrates scenario 1000C in an implementation. Scenario 1000C is representative of an operational scenario for handling multicast traffic with respect to the elements of FIG. 7. More specifically, scenario 1000C depicts a scenario for transmitting multicast traffic that originated from a module of the primary device. Scenario 1000C includes system 700, and peripherals 725 and 727.

To begin, CPU 721 transmits a data packet to host port 703 via the data path that serves as VHP 704, as indicated by the arrow labeled “1”. In response, host port 703 compares the data path metadata of the data packet to the TDPF-CFG values stored by registers 706 and 707 and determines that the data packet was transmitted across VHP 704. Host port 703 may then assert the SRB signal via the collection of wires which connects host port 703 to switch fabric 709. For example, when transmitting the data packet to switch fabric 709, host port 703 may cause the collection of wires to provide a binary value corresponding to the index of reflection port 711 to switch fabric 709. In response, switch fabric 709 bypasses the switch routing logic and transmits the data packet directly to reflection port 711, as indicated by the arrow labeled “2”.

Next, reflection port 711 determines that the data packet originated from CPU 721 based on the asserted SRB signal, and in response, deasserts the RTH signal and transmits the data packet back to switch fabric 709, as indicated by the arrow labeled “3”. Once transmitted, switch fabric 709 executes the switch routing logic to classify the data packet as either unicast, multicast, or broadcast traffic. For example, the switch routing logic may cause switch fabric 709 to compare the identifier of the data packet to the look-up table stored by memory 710 to determine that the intended recipient ports for the data packet include MAC ports 713 and 715. As a result, switch fabric 709 classifies the data packet as multicast traffic and generates two copies of the data packet. Once generated, switch fabric 709 respectively routes the first copy of the data packet, and the second copy of the data packet, to MAC ports 713 and 715, as indicated by the arrows labeled “4”. In response, MAC ports 713 and 715 respectively transmit the first and second copies of the data packet to peripherals 725 and 727, as indicated by the arrows labeled “5”.

FIG. 10D illustrates scenario 1000D in an implementation. Scenario 1000D is representative of an operational scenario for handling unicast traffic with respect to the elements of FIG. 7. More specifically, scenario 1000D depicts a scenario for transmitting unicast traffic originating from a module of the primary device. Scenario 1000D includes system 700, and peripherals 725 and 727.

To begin, CPU 721 transmits a data packet to host port 703 via the data path that serves as VHP 704, as indicated by the arrow labeled “1”. In response, host port 703 compares the data path metadata of the data packet to the TDPF-CFG values stored by registers 706 and 707 and determines that the data packet was transmitted across VHP 704. Host port 703 may then assert the SRB signal via the collection of wires which connects host port 703 to switch fabric 709. For example, when transmitting the data packet to switch fabric 709, host port 703 may cause the collection of wires to provide a binary value corresponding to the index of reflection port 711 to switch fabric 709. In response, switch fabric 709 bypasses the switch routing logic and transmits the data packet directly to reflection port 711, as indicated by the arrow labeled “2”.

Next, reflection port 711 determines that the data packet originated from CPU 721 based on the asserted SRB signal, and in response, deasserts the RTH signal and transmits the data packet back to switch fabric 709, as indicated by the arrow labeled “3”. Once transmitted, switch fabric 709 executes the switch routing logic to classify the data packet as either unicast, multicast, or broadcast traffic. For example, the switch routing logic may cause switch fabric 709 to compare the identifier of the data packet to the look-up table stored by memory 710 to determine that the intended recipient port for the data packet includes MAC port 715. As a result, switch fabric 709 classifies the data packet as unicast traffic and routes the data packet to MAC port 713, as indicated by the arrow labeled “4”. In response, MAC port 713 transmits the data packet to peripheral 725, as indicated by the arrow labeled “5”.

FIG. 10E illustrates scenario 1000E in an implementation. Scenario 1000E is representative of an operational scenario for handling unicast traffic with respect to the elements of FIG. 7. More specifically, scenario 1000E depicts a scenario for transmitting unicast traffic from a first module of the primary device to a second module of the primary device. Scenario 1000E includes system 700, and peripherals 725 and 727.

To begin, CPU 721 transmits a data packet to host port 703 via the data path that serves as VHP 704, as indicated by the arrow labeled “1”. In response, host port 703 compares the data path metadata of the data packet to the TDPF-CFG values stored by registers 706 and 707 and determines that the data packet was transmitted across VHP 704. Host port 703 may then assert the SRB signal via the collection of wires which connects host port 703 to switch fabric 709. For example, when transmitting the data packet to switch fabric 709, host port 703 may cause the collection of wires to provide a binary value corresponding to the index of reflection port 711 to switch fabric 709. In response, switch fabric 709 bypasses the switch routing logic and transmits the data packet directly to reflection port 711, as indicated by the arrow labeled “2”.

Next, reflection port 711 determines that the data packet originated from CPU 721 based on the asserted SRB signal, and in response, deasserts the RTH signal and transmits the data packet back to switch fabric 709, as indicated by the arrow labeled “3”. Once transmitted, switch fabric 709 executes the switch routing logic to classify the data packet as either unicast, multicast, or broadcast traffic. For example, the switch routing logic may cause switch fabric 709 to compare the identifier of the data packet to the look-up table stored by memory 710 to determine that the intended recipient port for the data packet includes reflection port 717. As a result, switch fabric 709 classifies the data packet as unicast traffic and routes the data packet to reflection port 717, as indicated by the arrow labeled “4”.

Once routed, reflection port 717 may determine that the SRB signal was not asserted with the data packet, and responsively assert the RTH signal. Reflection port 717 may then transmit the data packet back to switch fabric 709 to cause switch fabric 709 to bypass the switch routing logic and directly route the copies of the data packets to the appropriate VHP, as indicated by the arrows labeled “5”. In an implementation, to determine the appropriate VHP for directly routing a data packet, switch fabric 709 generates a sideband signal using the data stored by register 718. For example, switch fabric 709 may generate a sideband signal containing the RDPF-CFG of register 718. Once generated, switch fabric 709 may route the data packet and the sideband signal directly to host port 703. In response, host port 703 may analyze the sideband signal to determine that the data packet is intended to be sent across VHP 705. Once determined, host port 703 may utilize VHP 705 to transmit the data packet to CPU 723, as indicated by the arrows labeled “6”.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A packet switch device comprising:
a first port;
a second port;
a third port; and
a switch fabric coupled to the first port, the second port, and the third port;
wherein the second port is capable of receiving a data packet directed to a recipient coupled to the first port, and transmitting the data packet to the switch fabric;
wherein the switch fabric is capable of routing the data packet to the third port;
wherein the third port is capable of transmitting the data packet back to the switch fabric with an indication to route the data packet to the first port;
wherein the switch fabric is capable of routing the data packet to the first port based on the indication from the third port; and
wherein first port is capable of transmitting the data packet to the recipient coupled to the first port.

2. The packet switch device of claim 1:
wherein the data packet is a first data packet;
wherein the indication is a first indication;
wherein the first port is capable of receiving a second data packet directed to a recipient coupled to the second port, and transmitting the second data packet to the switch fabric with a second indication to route the second data packet to the third port;
wherein the switch fabric is capable of routing the second data packet to the third port based on the second indication from the first port;
wherein the third port is capable of transmitting the second data packet back to the switch fabric;
wherein the switch fabric is capable of routing the second data packet to the second port; and
wherein the second port is capable of transmitting the second data packet for delivery to the recipient coupled to the second port.

3. The packet switch device of claim 2, wherein the switch fabric includes switch routing logic, and wherein the second indication comprises a switch routing bypass (SRB) signal that causes the switch fabric to bypass the switch routing logic and route the second data packet to the third port.

4. The packet switch device of claim 1, wherein the switch fabric includes switch routing logic, and wherein the indication comprises a reflect-to-host (RTH) signal that causes the switch fabric to bypass the switch routing logic and route the data packet to the first port, and wherein the RTH signal further causes the switch fabric to append metadata to the data packet.

5. The packet switch device of claim 1 further comprising a fourth port, wherein the switch fabric is capable of routing a copy of the data packet to the fourth port, and wherein the data packet comprises multicast traffic or broadcast traffic.

6. The packet switch device of claim 5:
wherein the recipient coupled to the first port is a first recipient;
wherein the indication is a first indication;
wherein the fourth port is capable of transmitting the copy of the data packet back to the switch fabric with a second indication to route the copy of the data packet to the first port;
wherein the switch fabric is capable of routing the copy of the data packet to the first port based on the second indication from the fourth port; and
wherein the first port is capable of transmitting the copy of the data packet to a second recipient coupled to the first port.

7. The packet switch device of claim 1, wherein the first port comprises a host port coupled to multiple processing cores, and wherein the recipient comprises one of the multiple processing cores.

8. The packet switch device of claim 1, wherein the second port comprises a media access control (MAC) port and wherein the third port comprises a reflection port.

9. A system comprising:
a packet switch; and
multiple recipients coupled with the packet switch;
wherein the packet switch comprises:
a first port;
a second port;
a third port; and
a switch fabric coupled to the first port, the second port, and the third port;
wherein the second port is capable of receiving a data packet directed to a recipient of the multiple recipients, and transmitting the data packet to the switch fabric;
wherein the switch fabric is capable of routing the data packet to the third port;
wherein the third port is capable of transmitting the data packet back to the switch fabric with an indication to route the data packet to the first port;
wherein the switch fabric is capable of routing the data packet to the first port based on the indication from the third port; and
wherein first port is capable of transmitting the data packet to the recipient.

10. The system of claim 9:
wherein the data packet is a first data packet;
wherein the indication is a first indication;
wherein the first port is capable of receiving, from a source, a second data packet directed to a recipient coupled to the second port, and transmitting the second data packet to the switch fabric with a second indication to route the second data packet to the third port;
wherein the switch fabric is capable of routing the second data packet to the third port based on the second indication from the first port;
wherein the third port is capable of transmitting the second data packet back to the switch fabric;
wherein the switch fabric is capable of routing the second data packet to the second port; and
wherein the second port is capable of transmitting the second data packet for delivery to the recipient coupled to the second port.

11. The system of claim 10, wherein the switch fabric includes switch routing logic, and wherein the second indication comprises a switch routing bypass (SRB) signal that causes the switch fabric to bypass the switch routing logic and route the second data packet to the third port.

12. The system of claim 9, wherein the switch fabric includes switch routing logic, and wherein the indication comprises a reflect-to-host (RTH) signal that causes the switch fabric to bypass the switch routing logic and route the data packet to the first port, and wherein the RTH signal further causes the switch fabric to append metadata to the data packet.

13. The system of claim 9 further comprising a fourth port, wherein the switch fabric is capable of routing a copy of the data packet to the fourth port, and wherein the data packet comprises multicast traffic or broadcast traffic.

14. The system of claim 13:
wherein the recipient coupled to the first port is a first recipient;
wherein the indication is a first indication;
wherein the fourth port is capable of transmitting the copy of the data packet back to the switch fabric with a second indication to route the copy of the data packet to the first port;
wherein the switch fabric is capable of routing the copy of the data packet to the first port based on the second indication from the fourth port; and
wherein the first port is capable of transmitting the copy of the data packet to a second recipient of the multiple recipients.

15. The system of claim 9, wherein the first port comprises a host port coupled to the multiple recipients, and wherein the multiple recipients include multiple processing cores.

16. The system of claim 9, wherein the second port comprises a media access control (MAC) port and wherein the third port comprises a reflection port.

17. A packet switch device comprising:
a first port;
a second port; and
a switch fabric coupled to the first port and the second port;
wherein the first port is capable of:
receiving, from a source corresponding to the second port, a data packet directed to one or more recipients; and
transmitting the data packet to the switch fabric with an indication to route the data packet to one or more other ports associated with the one or more recipients via the second port.

18. The packet switch device of claim 17, wherein the switch fabric includes switch routing logic, and wherein the indication comprises a switch routing bypass (SRB) signal that causes the switch fabric to bypass the switch routing logic and route the data packet to the second port to cause the second port to transmit the data packet to the one or more other ports associated with the one or more recipients via the switch fabric.

19. The packet switch device of claim 17:
wherein the data packet is a first data packet;
wherein the indication is a first indication;
wherein the switch fabric is capable of receiving, from the one or more other ports, a second data packet directed to a recipient coupled to the first port, and routing the second data packet to the second port; and
wherein the second port is capable of receiving the second data packet and transmitting the second data packet back to the switch fabric with a second indication to route the second data packet to the first port;
and wherein the first port is capable of receiving the second data packet and transmitting the second data packet to the recipient coupled to the first port.

20. The packet switch device of claim 19, wherein the switch fabric includes switch routing logic, and wherein the second indication comprises a reflect-to-host (RTH) signal that causes the switch fabric to bypass the switch routing logic and route the second data packet to the first port, and wherein the RTH signal further causes the switch fabric to append metadata to the second data packet.
